(19) United States
(12) Patent Application Publication
(10) Pub. No.: US 2026/0227552 A1
(43) Pub. Date: Aug. 6, 2026

(54) ANAMORPHIC GRADIENT-INDEX MICROLENSES FOR COUPLING WITH PHOTONIC INTEGRATED CIRCUITS & THREE-DIMENSIONAL GRADIENT INDEX (GRIN) MICROLENS ARRAYS FOR LIGHT-FIELD AND HOLOGRAPHIC IMAGING AND DISPLAYS

(71) Applicant: Vadient Optics, LLC, Tualatin, OR (US)

(72) Inventors: George M. Williams, Vashon, WA (US); Charles Dupuy, Corvallis, OR (US); Jeremy Brown, Corvallis, OR (US); Samuel Grimm, Keizer, OR (US); Hooman Akhavan, San Diego, CA (US); J. Paul Harmon, Albany, OR (US)

(21) Appl. No.: 19/151,109

(22) PCT Filed: Jan. 29, 2024
(86) PCT No.: PCT/US2024/013367

§ 371 Date: Jul. 25, 2025

Related U.S. Application Data
(60) Provisional application No. 63/482,276, filed on Jan. 30, 2023.
(60) Provisional application No. 63/498,652, filed on Apr. 27, 2023.

(51) Int. Cl. G02B 3/00; G02B 6/42

(52) U.S. Cl. CPC G02B 3/0087; G02B 6/4206; G02B 6/4212

(57) ABSTRACT

A gradient-index optical film is configured to couple electromagnetic (EM) radiation into or out of a photonic integrated circuit.

### CROSS-REFERENCE TO RELATED APPLICATIONS

This application claims priority to U.S. Provisional Patent Application Ser. No. 63/482,276 filed 30 Jan. 2023 and entitled GRADIENT REFRACTIVE-INDEX SYSTEMS AND METHODS, the entirety of which is hereby incorporated herein by reference for all purposes.

### TECHNICAL FIELD

This disclosure relates generally to optical systems and more particularly to gradient-dielectric optics.

### SUMMARY

One aspect of this disclosure relates to an article of manufacture comprising a gradient-index optical film configured to couple electromagnetic (EM) radiation into or out of a photonic device.

In some implementations the EM radiation is ultraviolet, visible, infrared, or radio-frequency radiation. In some implementations the film comprises a cured coalescence of inkjet-printed droplets. In some implementations the droplets comprise two or more nanocomposite materials. In some implementations the film is achromatic such that the focal lengths at two or more wavelengths of the EM radiation are matched. In some implementations the film comprises two or more optical elements configured in an array of microlens or lenticular elements. In some implementations the optical elements are configured with optical phase modulators to effectively control light for beam steering and shaping. In some implementations the film is planar. In some implementations the film comprises at least one aspheric gradient, wherein the gradient has a polynomial form with power greater than two (r\hat{ }x, x>2) in at least one dimension. In some implementations the film comprises at least one gradient that changes its radial distribution as a function of the position along an optical axis. In some implementations the film comprises at least one non-radially symmetric optical channels. In some implementations the film comprises at least one round, square, rectangular, hexagonal, and/or oval shaped micro-optical elements. In some implementations the film comprises one or more opaque baffles configured to reduce scattering and/or crosstalk. In some implementations the film comprises at least one gradient that couples light from an angle other than the gradient axis. In some implementations the film comprises a surface shaped lens element configured in relationship to at least one aspheric gradient. In some implementations the film comprises at least one gradient-index function optimized for mode matching to a waveguide. In some implementations the film comprises at least one gradient-index function optimized for changing the shape of a light beam from one shape to another by altering the distribution of a light beam's intensity profile or its phase profile. In some implementations the film comprises at least one optical channels optimized for coupling light from a grating. In some implementations the film comprises a gradient-index function optimized for in-coupling or outcoupling EM radiation at a direction orthogonal to the photonic device.

Another aspect of this disclosure relates to a gradient-index optical film for coupling oriented EM radiation to or from a photonic integrated circuit, photonic imaging device, optical phased array, light-field display, lightfield imager, holographic display, or a micro-emitter array.

In some implementations the film is based on a bitmap, and wherein the bitmap is optimized using measured wavefront errors. In some implementations the film is printed directly onto a circuit, wafer, device, package, or panel.

### BRIEF DESCRIPTION OF THE DRAWINGS

FIG. 1 shows data measured on example, radially symmetric lenslets.

FIG. 2 shows binary print maps, theoretic design data, and measured data for two example lenslets, one radially symmetric and the other modified to be astigmatic, using Zernike polynomials.

FIG. 3 shows a picture of an inkjet-printed, additively manufactured lenslet array, and measured focal point data.

FIG. 4 shows an example wavefront map of a pupil plane of a lenslet, showing the anamorphic pupil plane.

FIG. 5 shows aspects of example 100-μm lenslet configurations.

FIG. 6 shows a wavefront map for an example radially symmetric lenslet configuration with axial variation.

FIG. 7 shows aspects of an example hex-packed hogel lenslet array with integrated mounting features and aspects of an example chirped lenslet array with anamorphic lenslet element

FIG. 8 shows a graph of the average focal length measurements obtained from a 35-mm by 45-mm area, seven by eleven element array of 4-mm-diameter radially-symmetric GRIN lenslet elements on a 5-mm pitch manufactured using mixes of different inks.

FIG. 9A shows aspects of an example series of micro-optical designs.

FIG. 9B shows theoretic root-mean-square (RMS) beam sizes at a one-meter viewing distance plotted as a function of the viewing angle, whereby a 0° viewing angle is normal to a display.

FIG. 10 shows aspects of a 3D GRIN hogel lenslet configuration.

FIG. 11 shows a photograph of 68-mm×121-mm, 90×160 element hogel array showing the projected picture of underlying graph paper, measured wavefront data showing the optical path difference at the pupil plane, and measured focal plane date.

FIG. 12 shows Zernike polynomial fitting of the wavefront error (WFE).

FIG. 13 shows aspects of a measured wavefront as a function of radial position

FIG. 14 shows photographs of an inkjet-printed lenslet array with baffle that extend through optical element defining the borders of each optical channel.

FIG. 15 shows a lenslet array design, developed for a head-mounted light-field display application wherein the optical axis of each lenslet is tilted relative to the others.

FIG. 16 shows aspects of a variable focus lenslet array.

FIG. 17 shows aspects of an example photonic device.

### DETAILED DESCRIPTION

### Section 1

This section relates to anamorphic gradient-index microlenses for coupling with photonic integrated circuits. Compact and efficient optical antennas are fundamental components for many applications. Despite decades of development, the problem of capturing light and coupling it into optical-fibers or planar waveguides persists. Inkjet print (IJP) additive manufacturing of freeform gradient index (GRIN) microlenses, which is compatible with large area and wafer level processing, offers a solution for coupling of optical information into and out of photonic integrated circuits (PIC) with relaxed alignment tolerances.

Inkjet print fabrication using dispersion-controlled nanocomposite optical feedstock allows monolithic optical elements to be fabricated that embed complex three-dimensional (3D) gradient index profiles that may include complex axisymmetric and non-axisymmetric high-order polynomial terms that make it possible to reduce aberrations and precisely orient and shape the optical wavefronts to achieve efficient coupling into waveguides. Moreover, baffles can be printed around each optical channel to reduce scattering and crosstalk.

To demonstrate these degrees of freedom, a series of aspheric and astigmatic 3D GRIN microlenses were inkjet print fabricated with a variety of aperture sizes, numeric apertures (NAs), and aspect ratios. The wavefront shaping properties of the microlenses were characterized and shown beneficial for photonics applications.

The demonstrated flexibility of the optics manufacturing platform enables complex 3D optics architectures to be realized that open unprecedented opportunities for developing new integrated systems in photonics and optoelectronics, with application in PIC, optical interconnects, optical phased arrays (OPA), phased array lidar, incoherent detection, optical communications, remote sensing, and biosensing or chemical sensing.

Compact and efficient optical antennas are fundamental components for many photonics applications. Like microelectronics, photonics progresses miniaturization with increased functionality, scalability, and low costs. The integration of multiple optical components, including high-density fiber-to-chip coupling on photonic integrated circuits (PICs) substrates, follows the progression of developments in electronics. As on-chip integration density increases, efficient off-chip interfaces are becoming more and more challenging. State-of-the-art commercial PICs now integrate thousands of elements, and increasingly larger numbers of optical interconnects are required to communicate between elements and for general input/output. This demand exceeds what is currently feasible with optical fiber coupling technology due to the large size mismatch between the optical fibers and photonic waveguide modal distributions and due to the limitations imposed by both the relatively large size of single and multi-mode fibers and the cost and complexity associated with their alignment. Because of this, coupling light to and from photonic components with large efficiencies remains a relevant challenge. Photonic coupling that allows for both out-of-plane and in-plane coupling are required that offers a flexible way of connecting external optical power with photonic chips, with different waveguide technologies.

These requirements extend to diverse fields of application. While photonics research has largely been focused on applications in the telecom and datacom industries, coupling lightfront optical antennas into and out of waveguides is a challenge faced by a number of applications including biosensing, incoherent photonic imaging, OPAs, and coherent-light beam steering and directional light detection. For example, over the last few years, there have been considerable research efforts in beam-steering systems that integrate large numbers of coherent emitters, including their phase and amplitude control, on a PIC.

Inkjet-print fabrication of GRIN micro-optical elements offers a flexible method of optimizing microlenses for optical power into and out of PICs. Using inkjet print fabrication, monolithic GRIN optical elements can be fabricated that include complex freeform and three-dimensional (3D) radially symmetric gradient index profiles. For example, 3D gradient profiles can be designed with high-order aspheric gradients that vary both axially and radially, which allow for a reduction in the influence of aberrations (e.g., spherical, coma, etc.), facilitate mode-field matching and beamshaping, and enhance coupling efficiency (CE). Moreover, benefitting from multi-materials composition, the nanocomposite materials may be formulated to allow for gradients to be formed with independent control over dispersion—a capability not possible with monolithic glass or plastic materials. This allows for wide-bandwidth operation and more efficient coupling to wavelength dependent gratings.

Inkjet printing allows for the GRIN profiles to be easily fabricated in a variety of aperture sizes and shapes, including anamorphic designs with axis-dependent numeric apertures (NA), and the flexibility of direct-from-digital fabrication allows for each lenslet size, orientation, and optical axis orientation to be varied as a function of its position within the optical field. This allows application-specific optimization including chirped or foveated MLA designs to be implemented.

Due to the sub-micron dimensions of on-chip waveguides, coupling light from the external world poses a significant challenge; highly precise alignment accuracies are needed to ensure optimal CE. A number of different solutions have been developed, which can generally be categorized as edge coupling or grating coupling.

Edge-coupling (also indicated as ‘in-plane’, ‘end-fire’, or ‘butt’ coupling) is typically utilized for telecommunication applications, since it provides low coupling-loss, large spectral bandwidth, and low-sensitivity to polarization. In this case, the light beam is coupled in/out from the waveguide from lateral sides, thus always propagating in the same plane. Edge-coupling can offer low insertion-loss (IL), but requires very tight alignment tolerances, often on the sub-micron level, and can be difficult to implement at scale. The main drawbacks are its tight alignment tolerances (i.e., sub-micron level) and the need for sophisticated packaging procedures.

A variant approach for edge-coupling is to embed reflecting mirrors in the waveguides to re-direct light perpendicular to the waveguide. Metal mirrors have good light steering behavior, and are preferred in applications requiring broadband functionality, wavelength, and polarization insensitivity.

A widely adopted option is to employ vertical coupling using diffractive gratings. When this technique is adopted, the light beam is incident from the top- or bottom-surface of the chip, and a suitably designed coupling structure changes the off-plane wave-vector direction of light to the in-plane waveguide direction, and then couples the light into waveguide, generally using a spot-size converter. Vertical grating couplers (GC) are flexible in terms of arbitrary on chip patterning, relaxed positioning tolerances, compact size, ease of lithographic fabrication, and multipoint wafer-level testing capability. As a result, optical antennas based on GCs have been widely used to interface integrated circuits with optical fibers as well as for freespace coupling applications such as integrated OPAs, wherein dense packing generally makes edge emission impractical. However, although GCs have the above-mentioned advantages, they also have significant drawbacks including low coupling efficiency (~−4 dB), narrower spectral BW (~40 nm), and intrinsically sensitive to both wavelength and polarization.

A grating is basically a varying arrangement of different materials or structures, usually periodic. On a PIC, either etching or deposition creates refractive index variation, and for a uniform GC, each diffraction unit has the same ability to diffract light. If the index variation has a period larger than the wavelength of light inside the grating material, diffraction effect prevails. Otherwise, the light propagation in a grating will exhibit similar feature as uniform medium, which becomes more significant as its period decreases.

Depending on the chosen structure, the behavior of surface gratings can be controlled by a number of design parameters. The efficiency of a GC is generally improved by enhancing directionality (or reducing back-reflection and substrate loss) and increasing modal overlap. A number of solutions have been proposed for increasing vertical GC efficiency.

The efficiency of coupling light into the PIC depends on matching the angle and wavelength such that the diffracted light is in phase with the modes of the waveguide. This requires precise control of the grating parameters and the incident light. The grating essentially serves as an intermediary that adjusts the direction and possibly the effective wavelength of the light so that it matches the mode of the waveguide in the PIC.

Using standard diffraction grating the Bragg condition does not allow for perfectly vertical coupling, ideal vertical coupling (θ=0). With a standard grating, when light hits the grating, it can be scattered in multiple directions, both forward and backward relative to the incidence light. Thus, the diffraction angle is often designed to be slightly offset from the chip surface normal direction to suppress back-reflections and avoid high reflections into the input waveguide from the second-order diffraction. This can introduce additional challenges in fiber coupling or alignment with other optical antennas, resulting in a restriction of the channel density and an increase in packaging complexity.

Coupling a free-space optical signal into a waveguide requires matching up the free-space optical field at the waveguide input to the pattern of fields that can propagate in the waveguide as guided modes. Generally, optical waveguides are constructed with some sort of high-refractive-index core surrounded by a low-index cladding; excited energy in the guided modes is confined to the central area of the core. Energy that doesn't overlap with the guided modes in the cores is lost.

Coupling optical signals from a multi-mode fiber (MMF) or a single-mode fiber (SMF) into a PIC waveguide often requires that a micro-optical coupling be used to mediate the difference between the mode field diameter (MFD) of the fiber and the waveguide. Major GC losses may also be attributable to the modal mismatch between a Gaussian fiber mode and grating diffraction profile.

Microlens elements and microlens arrays (MLAs) provide the capability to couple light into and out of PICs. A MLA is an array of small lenslets formed inside or on one or more surfaces of a common substrate. A challenge of optimizing MLA designs for efficient coupling into PICs, is the limited number of available fabrication methods. Owing to limited precision and the available manufacturing process tolerances, at the small geometric scales required for coupling into waveguides, errors are introduced into the MLAs. These occur primarily as shape error between the actual surface and the ideal face shape, which causes sag errors, irregular deformation, change in curvature radius, coordinate distortion and other defects, the nature of which may vary at different locations of an array.

To mitigate geometric and chromatic aberrations, optical systems typically utilize a combination of lens elements, each possessing unique surface curvatures and composed of materials with distinct refractive indices and dispersion properties. However, the alignment of multiple microlens arrays presents practical challenges and is difficult to sustain across varying temperatures. Traditional manufacturing methods for multi-element lenslet systems require meticulous alignment and the precise crafting of surfaces on either side of a material with a set thickness. This restriction constrains the potential of compound lens designs. Furthermore, the use of a common material system for the aligned lenslets means that chromatic aberrations continue to be an issue. These factors limit the ability of microlenses for reducing aberrations.

A result of the large non-uniformities, high surface roughness, losses due to absorption and scattering, and axis-independent numerical apertures, is that existing microlens arrays are sub-optimal for coupling light into PICs, necessitating new approaches capable of improvements in optical throughput.

The most used physical and chemical methods for fabricating MLAs are direct fabrication methods that include photoresist reflow, gray scale lithography, photolithographic ion exchange technology, microplastic embossing, microdroplet jetting, etc. However, with these techniques, the properties of the optical materials are limited. Also, due to the complex processes used in direct fabrication methods, it is difficult to control the lenslet radius of curvature (RoC) and to implement aspheric surfaces, to achieve high fill factor, and to fabricate tightly packed lenslet arrays.

Indirect fabrication methods are those that manufacture using replication. Because metallic molds must be made using ultra-precision machining, most molding methods are expensive. The most cost-effective indirect fabrication techniques use polymer materials along with hot embossing or UV molding replication techniques. In addition to the limited types of materials available with these methods, one of the biggest challenges is to reproducibly achieve the high surface-coverage ratio necessary for lower optical loss and higher focusing efficiency. The material property limitations, combined with process complexity, restricts the complexity of allowable lenslet shapes and limits replication at industrial scales.

More recently, two photon polymerization stereolithographic printing techniques have been adopted for use in the fabrication of micro-optics with complex profiles. Although the process is superior to other fabrication methods for use in prototyping, the low production efficiency and limited working dimension impedes its wider applications in optical manufacturing, especially in large-area micro-optics. The dispersion properties of compatible materials also make chromatic aberrations a problem. Moreover, plastic materials exhibit temperature sensitivity, and they are generally not compatible with space environments. Therefore, these methods are most often used to create one-off prototypes or limited production molds for use in indirect fabrication. Only a few technologies have been applied in commercial product manufacturing. These include early examples of lens fabrication, light guide prototyping, and a number of special function components.

Thus, while 3D printing has developed into a mature technology in a range of industries, its progress in the field of optics has been limited.

To address the needs of fabricating micro-optical systems, NanoVox has developed a custom additive manufacturing technology platform, called ‘Variable Index of Refractive Gradient Optics’ (VIRGO™) that uses inkjet printhead deposition of spectrally tailored compositions of optical nanocomposite feedstock.

The properties of the printable primary ‘optical ink’ feedstocks play an important role in inkjet constructed optical elements. The refractive index spectra (n_{λ}) of the optical inks are precisely tailored to the application. The nanocomposite optical feedstocks are formulated by embedding one, or more, non-scattering organic or ceramic nanoparticles in one, or more, low-viscosity optical-grade photocurable monomers. Each nanoparticle is small (e.g., <~10 nm, less than 1/30th the wavelength of light passing through the optic) and is chemically coated to eliminate agglomeration, such that Rayleigh and Mie scattering are insignificant. The optical inks are formulated with the rheological properties necessary for reliable inkjet printhead deposition.

At minimum, using inkjet print fabrication, two optical inks are necessary to create a GRIN element, for example, a ‘high index’ optical ink, with index, n₀(λ), and a ‘low index’ optical ink with index, n₁(λ). The difference in the index values of the two primary inks is the refractive index contrast, Δn(λ)=n₀(λ)−n₁(λ). The difference in the index values can be used to create optical power by bending incident light in different magnitude as a function of the position on the optical element. For example, by creating a radially-symmetric gradient that starts with 100% high index ink at the center, a gradient profile can be created n(r,λ)=n₀(λ)−Δn(λ)(αr²/R²), by mixing the two optical inks in proportion to the radial scaling factor, a, A unique feature of multi-constituent nanocomposite optical inks is that it is possible to precisely tailored the refractive index spectra of the optical inks relative to one another, to control primary and secondary color.

Increasing the number of primary optical inks expands the degrees of freedom, providing more ability to create sub-wavelength accurate index gradients and providing more control over secondary color characteristics. The number of primary optical inks that can be printed simultaneously is limited by the number of available printheads. For the simple case of a binary ink set (i.e., a ‘high index’ and a ‘low index’ optical ink) at least two printheads are required. To construct each gradient index patterned layer of the optic, requires a separate bitmap for each printhead. The bitmaps define the drop density patterns of each primary optical ink for each pass of the printhead over the substrate.

The bitmaps are designed using ‘halftoning’ algorithms. The halftoning algorithms quantize the refractive index profiles of the design. The quantization level is determined by the number of primary optical inks used for fabrication; for example, using binary optical ink pairs, single-level-threshold quantization may be used. The single-level threshold may be fixed or dynamically variable. After quantizing a voxel element, the residuals of the quantization are distributed to neighboring voxels that have not yet been processed. The errors may be distributed in different proportions to different distances in any of the three dimensions. The process continues until the layers of print maps for each printheads are complete.

‘Print composition’ is used to create the intermediate values of the gradient profile. The pattern that droplets are deposited is defined by the bitmap for each primary optical ink. Printing the droplet patterns results in patterned concentrations of droplets, which after interdiffusion with neighboring droplets, results in patterns of varying material composition, which are defined by the local concentrations of all of the constituents of the co-deposited optical inks. After polymerization, the local refractive index spectra assume a value that can be approximated by the weighted average of the constituent spectral properties.

Increasing the number of primary optical inks to include intermediate-index value allows for multi-level halftoning. Multi-level thresholding reduces quantization error and by reducing the magnitude of diffusion required to achieve a desired voxel composition, enables more precise control over the gradient index patterns. Simultaneous printing of multiple inks also provides degrees of freedom for controlling dispersion and secondary color.

The stack of print maps, one for each printhead each layer, are uploaded to the printer when fabricating the optic. Using industrial printers, the drop placement of the optical inks can be controlled to better than one micron precision, and after inter-diffusion and polymerization of the different concentrations of droplets, optical inks and polymerization, it is possible to fabricate complex sub-wavelength-smooth gradient profiles that do not scatter light.

Using a single commercial inkjet printer, 1-cm MLAs arrays can be made, directly from digital files, at a production rate of thousands per hour. Hundreds can be made simultaneously on one meter scale print platforms. The planar GRIN optical elements can be printed with better than λ₆₃₂ₙₘ/10 flat surfaces, without post-processing. Due to the benefits of the ceramic nanoparticles, which are inter-dispersed and tightly crosslinked within the polymer matrix, the nanocomposite optical materials may be polished or shaped to high precision industry standards, and they can be coated at temperatures up to about 140° C. The nanocomposite optical materials have many desirable properties, they are non-hydroscopic, and they have good hardness, strength, and durability. They are much more temperature stable, have lower coefficient of thermal expansion (CTE), and have better dn/dT than plastic materials. They have also been shown to tolerance of relevant space radiation environments and show low outgassing characteristics in a vacuum.

The bottom-up, inkjet printing process allows complex optical functions to be implemented in monolithic plano-plano (‘flat’) flat optics, without the need for tooling. The 3D GRIN optics can also be fabricated directly on PIC wafers, or other substrates. This makes it possible to facilitate efficient coupling to PICS, by implementing multiple micro-optic channels consisting of high-order radial aspheric GRIN functions, as well as complex non-axisymmetric gradient index terms, in which the functions are defined in both the radial and axial directions.

Using complex 3D GRIN functions, it is possible to reduce aberrations (spheric, coma, etc.) and to shape the spatial mode distributions. For example, tilt may be added to the GRIN print maps to achieve a non-perpendicular out-of-plane wave-vector direction, and one or more astigmatic terms can be included in the design to achieve the non-symmetric numeric aperture (NA) values required to achieve more efficient coupling to a rectangular grating and facilitate spatial mode matching into an in-plane waveguide. For OPA applications, it is also possible to use the 3D GRIN functions to shape the outgoing beam, for example, with a tophat, or other function.

These degrees of freedom (DOF), implemented in a flat monolithic optical element, replace the optical functions of multiple homogeneous index optical elements, without the need for opto-mechanical alignment and stabilization.

Furthermore, using drop on demand printing, it is straightforward to change the size, the aspect ratio, and the optical-axis-orientation of each microlens individually across an array. This flexibility allows printed microlenses arrays to be easily optimized for PIC applications.

TABLE 1
Characteristics of Fabricated Microlens Arrays.

| | | | | | | Spot | |
|---|---|---|---|---|---|---|---|
| Lenslet | | | Aspect | Array | Dimensions | size | |
| (μm) | GRIN Design (before Z4) | NA | Ratio | Format | (lwh, mm) | (μm) | Uniformity |
| 756 | n = 1.535 − 0.081r² + | 0.884 | 1:1 | 90 × 60 | 68 × 45 × 1 | 4 | 1.15% |
| | 0.03r⁴ − 0.363r²z + | | | | | | |
| | 0.002153r²z² + 0.186r⁴z − | | | | | | |
| | 0.138r⁴z²+ | | | | | | |
| 320 | n = 1.5508 − 0.1934r | 0.25 | 1:1 | 32 × 32 | 10.24 × 10.24 × 1 | 4.5 | 7% |
| 160 | n = 1.5508 − 0.7734r | 0.08 | 1:1 | 144 × 144 | 23 × 23 × 1 | 4.1 | 10% |
| 160 | n = 1.5508 − 0.7734r | 0.07 | 1:1 | 44 × 44 | 7.14 × 7.14 × 1 | 9.95 | 4.5% |
| 160 | n = 1.5508 − 0.7734r + Z4 | 0.036/0.014 | 2.57:1 | 44 × 44 | 7.14 × 7.14 × 1 | 24/9 | 8.60% |
| 100 | n = 1.52 − 15.962r² + | 0.025/0.014 | 1.78:1 | 200 × 200 | 20 × 20 × 1 | 23/13 | 40% |
| | 154.221r⁴ + Z4 | | | | | | |

To demonstrate these degrees of freedom for PIC applications, a series of microlens arrays, with lenslet diameters ranging from below 100-microns to over 750-microns were built and characterized. Table 1 show the distribution of the gradient index profiles for each design, including those that are modified to include astigmatism (Z4). The arrays were fabricated with different formats, sized up to 2-cm square.

A customized graphics printer (Gen2) was used to print microlenses sized 756-μm diameter microlens. The Gen2 printer has 21 pL droplet sizes, providing a 75 DPI (drops per inch) native resolution. The printheads are sized about 75-mm, so large arrays can be fabricated in a single swath. The full 600 DPI resolution (42 micron) is achieved in six inter-leaved passes of the printhead. The printer deposits optical ink at about 300 cc/hour which makes it possible to print several hundred 1-cm square MLAs per hour.

A binary ink pair was chosen for the Gen2 printer based on the NanoVox model VZBXX070 high-index optical ink, which has a mid-wavelength index of 1.5376, and model VYBXX010 low index, which has a mid-wavelength index of 1.4914 was used to fabricate a series of microlens arrays. The primary optical ink pair is characterized by a GRIN Δn of 0.12.

A research printer (Gen1) with 1 pL drop sizes was used to print the microlenses sized 360-μm in diameter and smaller. The Gen1 printheads have 16 nozzles per printhead that are configured in a narrow, i.e., 0.159 mm, print swath, with a 16 DPI resolution. Thus 62 passes are required to print a 1-cm dimension MLA, and full 4233 DPI resolution (10.5 μm) is achieved in 256 interleaved passes.

With high-rate deposition in the direction of printhead movement, the lenses are rapidly composed, limited only by the kHz-rate nozzle ejection rates. So, in the x-direction, adjacent droplets are deposited within a millisecond of one another. In the cross-scan direction, the interleaved rows are deposited only after the carriage has moved over the print platform, so there can be delays of over a second between adjacent rows.

A binary ink pair was chosen for the Gen1 printer based on the NanoVox model VZBXX070 high-index optical ink, which has a mid-wavelength index of 1.5376, and model VZXXX000 low index, which has a mid-wavelength index of 1.4914 was used to fabricate a series of microlens arrays. The primary optical ink pair is characterized by a GRIN Δn of 0.0462.

Before printing, the nanocomposite primary optical ink formulations were spectroscopically characterized. The refractive index values for the inks were measured using an Atago Abbe refractometer. The ink compositions were verified using a TA Instruments TGA-2950 Thermo Gravimetric Analyzers with a TA Instruments DSC-2920 Differential Scanning calorimeters (DSC Q2000). Before printing, the rheological properties (viscosity, surface tension, density, etc.) of the inks were characterized, so that the relative magnitude of the fluid's interfacial, viscous and inertial forces, where within the bounds of drop ejection for the printheads.

For each lenslet design, bitmaps were created for each ink, taking into consideration the diffusion properties of the inks. For the binary primary optical ink pair, two bitmaps were required per layer, one each for the ‘high index’ and ‘low index’ optical ink. The 750-μm-diameter lenslet design included both radial and axial terms, which required that bitmaps be created for each layer of the optic. A series of progressively smaller diameter lenses were then made. For the smaller diameter designs, only radial index terms were used in the GRIN profiles, so the same bitmaps could be used for each layer.

After confirming the properties of various diameter lenslets, aberrations were introduced into the GRIN profiles by adding Zernike polynomials to the print maps to change the aspect ratio of the microlenses.

Table 1 summarizes the properties of the series of lenslet arrays fabricated. Close to 100% yield was obtained across the fabricated arrays. The parts were tested ‘as printed’ with no post fabrication processing.

The parts were characterized using a custom digital holographic microscope. Wavefront maps of the pupil planes were used to confirm that the gradient index profiles were fabricated, as intended. Zernike decomposition of the wavefront error (WFE), obtained by comparing the measured data to an ideal spherical wavefront, was used to identify aberrations (spherical, coma, etc.), such that the print maps could be compensated and the aberrations.

For the 756-μm-diameter parts, aberrations are reduced by adding higher order aspheric GRIN terms, including gradient profiles that vary along the optical axis. Furthermore, Zernike analysis allowed printer-specific biases to be identified. After optimization of the print maps, about 1.15% focal length non-uniformity was measured.

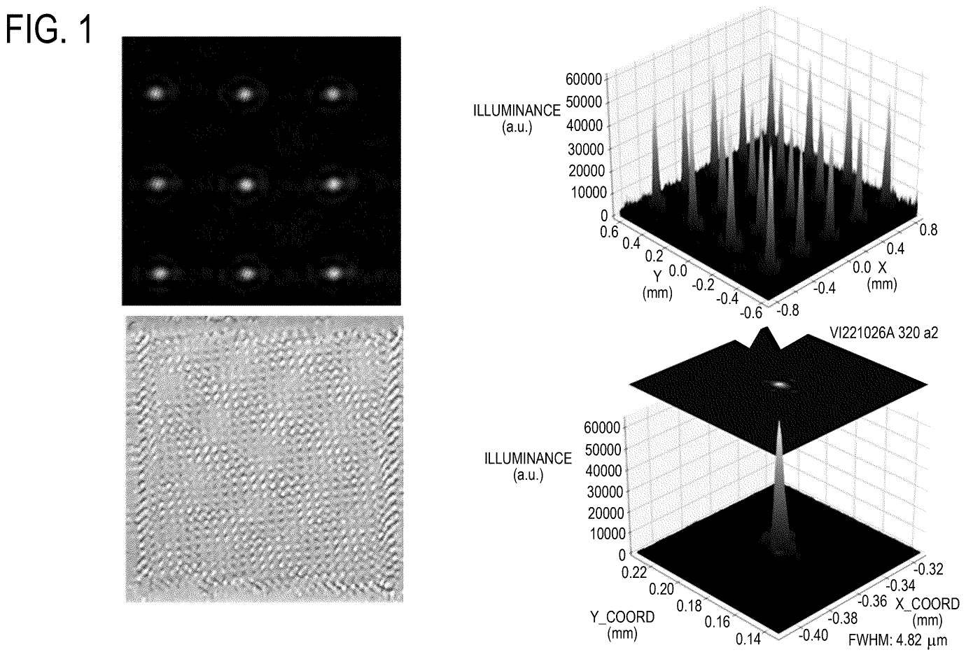

FIG. 1 shows data measured on the radially symmetric, 320-μm diameter lenslets. More specifically, the drawing shows (upper left) the measured point-spread function at focal plane, (lower left) an image of the lenslet array over fine grid paper, (upper right) focal length 575 μm+/−43 μm measurements, and (lower right) measured 4.82 μm FWHM focal point measurements. FIG. 1 provides plot of the well-structured 4.82 μm FWHM focal point. The average measured focal length across the array was 575 μm+/−43 μm (7.4%) measured across the across the array.

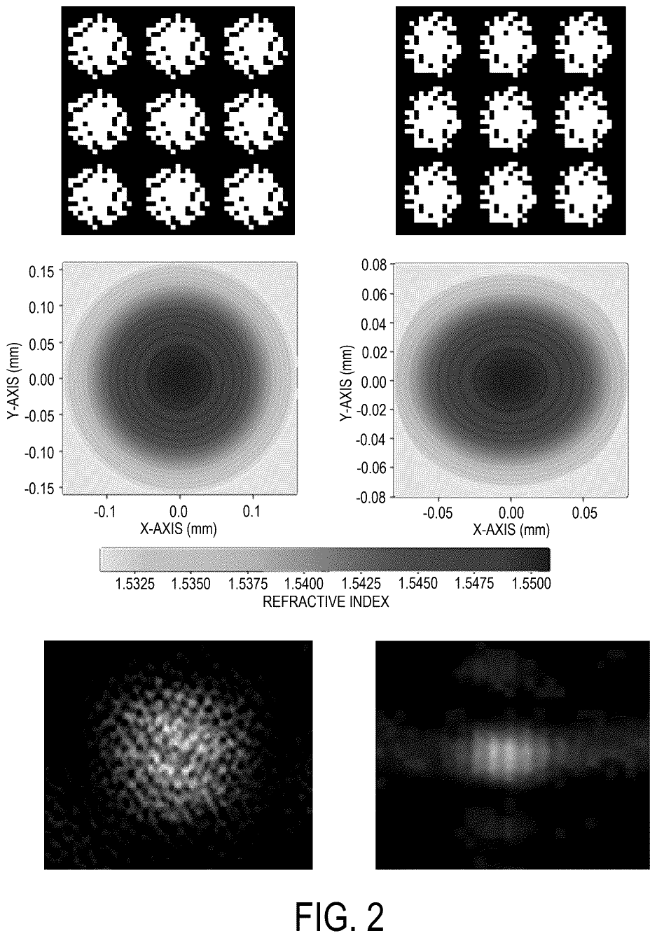

FIG. 2 shows the design and measured data for the 160-μm-diameter lens—viz., (left side) 1:1 round lenslets, (right side) astigmatic 2.5:1 lenslet with 0.2 waves Z4, (top) lenslet binary artwork, (middle) GRIN profile, (bottom) measured point spread function (14.1-μm diameter without Z4 and 9.4-μm×23.5-μm with Z4 astigmatism). The data on the left of FIG. 2 shows data describing the radially symmetric microlens elements and the data on the right side shows data for the 2.57:1 anamorphic microlens element, wherein astigmatism was added to the original design by including 2 waves of the Z4 (astigmatism) Zernike polynomial.

On the top row are a portion of the binary bitmaps used for fabricating the MLA. In these figures, the black represents areas where the low-index inks are deposited, and the white area is where the ‘high index’ inks are printed. The bitmaps are obtained by quantizing the GRIN profiles that are shown in the middle row. On the bottom row are the measured point spread functions, obtained using the DHM. The difference between the left and right images demonstrates the ability to achieve axis-dependent NA (i.e., 2.57:1) for more efficient coupling to rectangular diffraction gratings. Adding higher order Zernike terms can be used to further shape the focal point to improve coupling.

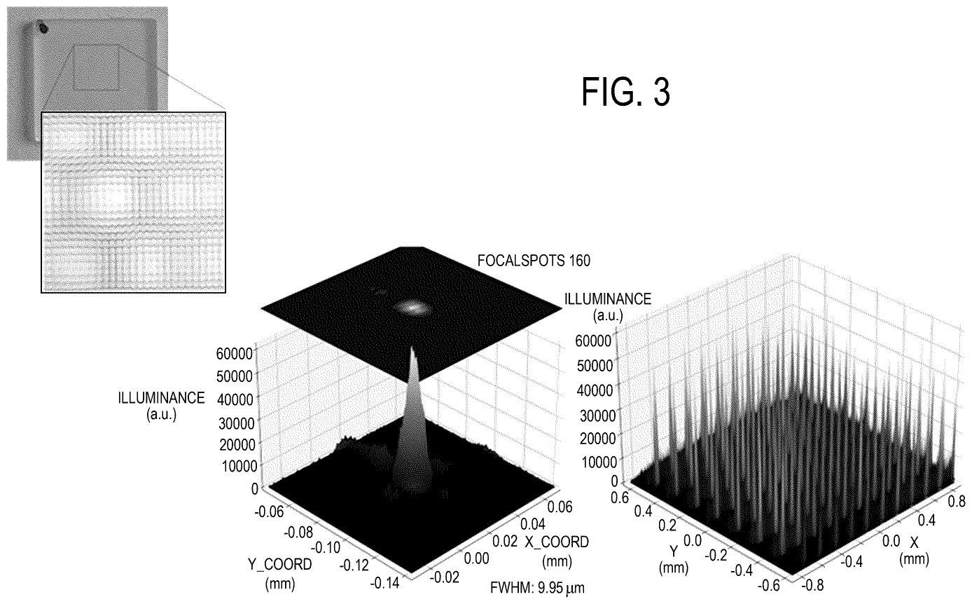

FIG. 3 shows additional data from the 160-μm diameter lens—viz., (left) lenslet array imaging underlying graph paper, (middle) point spread function (9.95 μm), (right) focal length measurements (1.1-mm+/−0.05). The picture of the MLA (FIG. 3, left) shows the projected image of an underlying grid paper. The focal length measurements were 1.1-mm+/−0.05 (4.5%), which show good uniformity for ‘first article’ fabrication. The measured point spread function, shown in FIG. 3, right was 9.95-μm FWHM.

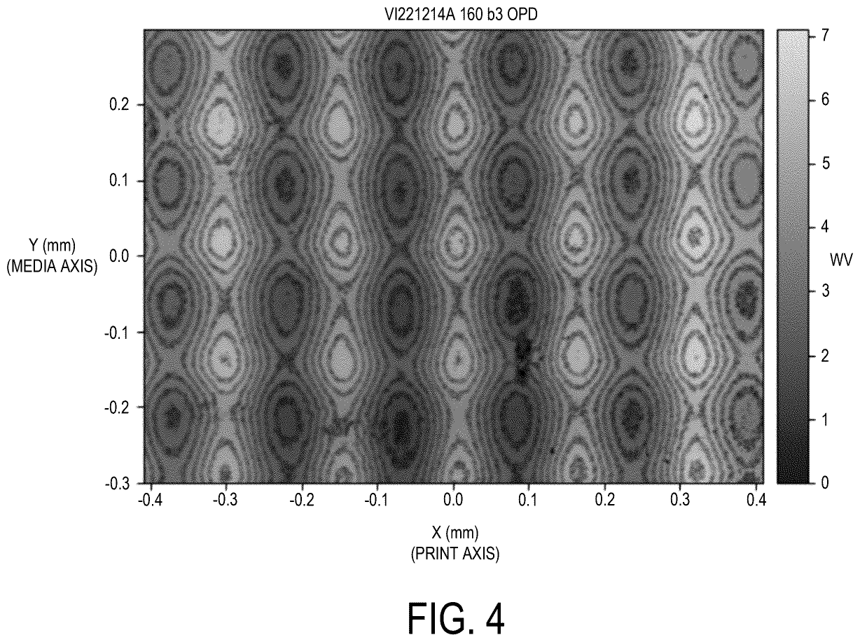

FIG. 4 shows the wavefront map of the pupil plane, of the astigmatic part, including the anamorphic pupil plane—viz., for a 160-μm diameter part (astigmatic) holographic microscope wavefront measurements of pupil plane.

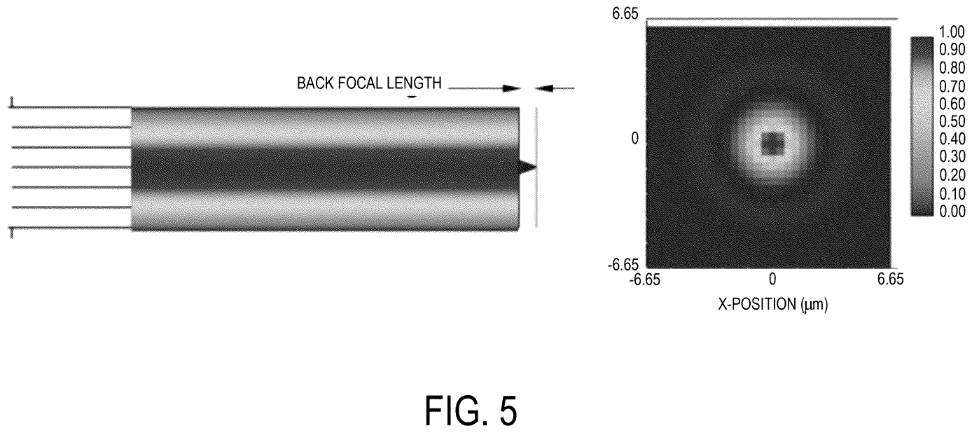

FIG. 5 shows the 100-μm lenslet designs—viz., (left) axial cross section of 100-μm-diameter lenslet design; (right) modeled focal spot size at the focal plane (no astigmatism added).

As the microlens diameters were decreased the non-uniformity increased. This is not surprising; whereas the 750-μm diameter microlenses were fabricated on a graphics printer (Gen2) with multiple 75-mm wide printheads, which with over 1,000 nozzles, each layer of a 1-cm square microlens can be fabricated in one, or a few passes.

The smaller microlenses were printed on research printer (Gen1) used to fabricate the smaller MLAs, is configured with printheads that each have only 16 nozzles that are configured in a narrow, i.e., 0.159 mm, print swath. With high nozzle ejection rates, the microlenses lenses are rapidly composed along the x-axis (the direction of printhead movement) and adjacent droplets are deposited within milliseconds of each other. However, along the y-axis, the MLAs due to the small swath width and low nozzle counts of these printheads, they need to be composed by interleaving print swaths. As a result, about 62 interleaves passes are required to compose the 1-cm y-axis (direction of platen) dimension of the MLA. Each pass travels the entire length of the print bed, which results in a significant differential in the time adjacent voxels are deposited in the y-direction.

High quality 100-μm and smaller lenslets were later printed with a printer (Gen4) configured with found 30-mm printheads, each with about one thousand nozzles, that deposit 3 pL droplets, which allows for eighteen-micron dimensions voxels to be created.

The inter-diffusion of droplets is governed by several factors, including the size of the nanoparticle, the surface functionalization and chemical interaction of the nanoparticles and the monomers, the viscosity of the optical inks, the nanoparticle concentration gradients, temperatures, as well as external field. Marangoni flows can significantly impact the distribution and organization of nanoparticles within the monomer.

It is possible to compensate the print maps to accommodate diffusion. This may be done by adjusting the bitmaps to account for diffusion, such that after deposition and inter-diffusion the composition of the material best matched the GRIN design. The amount of compensation may be determined theoretically by using diffusion models, or the compensation many be determined empirically.

The compensation may also be used to compensate for non-uniform diffusion, such as occurs when materials adjacent to a voxel are deposited at different time. One may compensate for fabrication biases using Zernike polynomial decomposition of the WFE. The simplest method for correction is to add or subtract compensating Zernike terms to the print maps such that the WFE is minimized. As demonstrated herein, this is effective in optimizing the optical properties of printed MLAs.

The same approach can be used to further reduce aberrations in each lenslet channel. Using the measured WFE of printed optical elements allows for the bitmaps to be compensated such that the fabricated parts best match the intended design. Analysis of the WFE also allows for closed loop process control and monitoring.

When correcting for aberrations, the designs generally assume more complex gradient index cross-terms, which vary both radially and axially. Inkjet printing readily accommodates gradient index complexing, but these capabilities are generally limited by the resolution of the printer. For the Gen1 printer, with a 1 pL droplet, which forms a voxel about 10.5-μm in diameter, each layer of a 160-μm-diameter lenslet is composed of about 232 droplets, and a 100-μm-diameter lenslet by 91 droplets. Using simple geometry, reducing the droplet size to 0.25 pL (about 5.3-μm diameter voxels), the layers of the 160-μm-diameter lenslet can be composed of 915 droplets, a 100-μm diameter lenslet by 357, and 60-μm diameter lenslet by 129 droplets. Additionally, the number of droplets in contact with the border are reduced proportionally, which aides in reducing aberrations.

Modern industrial printers have large nozzle counts and large swaths, which can allow the layers of MLA designs such as these, to be deposited in a single swath, which combined with manufacturing control provided by finer resolution, will allow even better results to be obtained. Nevertheless, the performance of the ‘first article’ GRIN lenslets is quite remarkable, compared to existing approaches.

Based on the measured results, a 24-element array of GRIN microlens coupling elements, aligned on a 720-μm, is optimized for OPA applications. The operating principle is as follows: the photonics chip consists of a directionality based grating couplers that diffracts the optical waveguide mode at an angle into the bulk substrate, or spacing material. The diffracted Gaussian-shaped beam expands in the spacing layer and is then collimated and beam-shaped with the help of GRIN microlens with a particular radius of curvature. For many applications, ideally, the beam is shaped with a tophat profile.

In this design a 1.5 mm thick (T_{sub}=1.5) spacing layer is positioned between the GC and the 3D GRIN microlens. The Bragg coupler is designed such that the Gaussian laser beam from the coupler is tilted θ~8 degree to avoid back-reflections into the waveguide. The total lens width was limited to 0.72 mm (W_{GRIN}=0.72), and the width of the output beam emerging from the lens is about 635 μm (W_{GRIN}=0.635). The goal was to flatten the output wave, so that as nearly a ‘tophat’ beam profile as possible could be achieved in a small package.

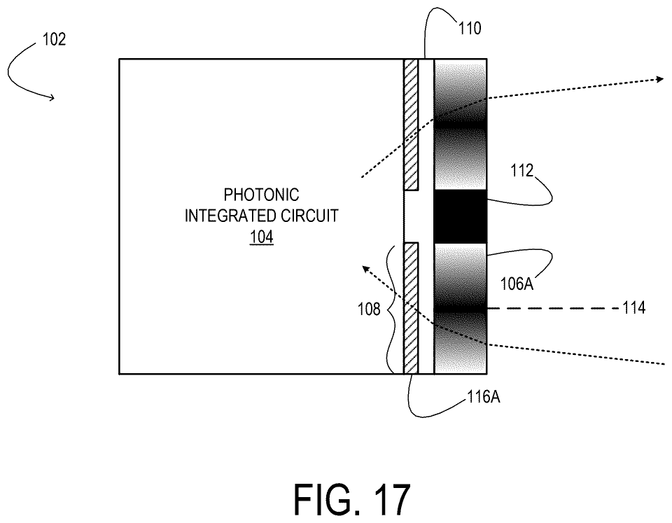

An object space NA with Gaussian apodization was used to simulate a Gaussian laser beam from a Bragg coupler in ZEMAX sequential ray tracing. In the Zemax merit function editor (MFE), 3 rings and 6 arms with Gaussian Quadrature for the pupil were applied to shape the output beam. Monitoring the Huygens PSF, the wavefront map, the slope of the enclosed energy diagram, beam tilt, and divergence were used to track the output beam as a function of design parameters. Aspects of this arrangement are described hereinafter, in the context of FIG. 17 (vide infra).

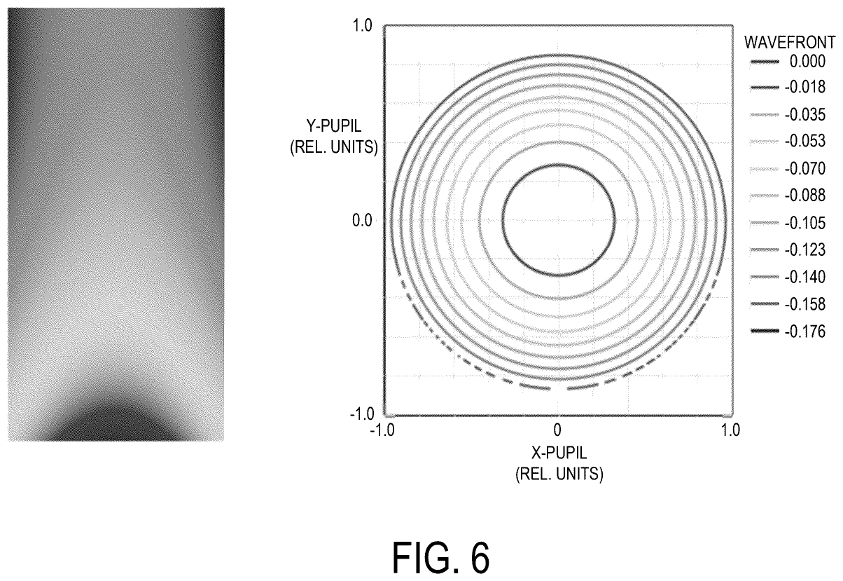

FIG. 6 shows the wavefront map for an example lenslet configuration—viz., (left) axial cross section of 3D GRIN microlens; (right) wavefront measurements of pupil plane. The maximum OPD in the exit pupil is 0.18 waves. The higher order radial terms of the GRIN profile allow for the PSF to be localized and sharpen the slope of the enclosed energy diagram. The higher Δn results in a narrower Gaussian beam shape. The radial distribution changes as a function of the axial position allows for large collection angles, with reduced aberrations. With proper values for higher order radial and axial terms a more uniform wavefront map and reduced OPD may be achieved.

A high-throughput, repeatable method of fabricating microlenses for coupling to photonic integrated circuits (PICs) was demonstrated. The process has been demonstrated to be compatible with a variety of substrates, including processed CMOS wafers.

Given the limitations of existing manufacturing approaches, the ability of printed 3D-GRIN micro-optical elements as an attractive approach to beam forming and out-of-plane deflection of light in integrated PICs was clearly demonstrated. Demonstrated herein is the ability to fabricate MLAs, which included high order aspheric gradient index terms, including astigmatic terms that allows the point spread functions to be optimized for rectangular grating couplers to enable more efficient coupling.

These arrays are among the first GRIN lenslet arrays reported. Most processes for fabricating GRIN elements are incompatible with non-radially symmetric profiles, which prohibits fabricating non-axi-symmetric optics such as MLAs, which are structured freeform optics.

Overall good focal length uniformity and high-quality point spread functions were obtained. However, as anticipated, as the lenslet diameters became increasingly printer artifacts became more pronounced. These artifacts are attributable to the properties of the research printer, which resulted in directionally dependent (non-symmetric) diffusion of the printed droplets. While it is possible to calibrate the printer-specific biases, such compensation was not attempted in this effort.

Use of a printer with a wider swath width, that can deposit all droplets simultaneously would allow for more engineering control over the resulting gradient index profile properties. Additionally, printheads with the ability to accommodate higher viscosity inks, would allow for nanofiller loading densities with Δn=0.2, allowing for the GRIN lenslets to be about 5 times thinner than shown here.

Whereas the larger 756-μm-diameter lenslets included sophisticated GRIN profiles, including both radial and axial terms, the smaller diameter lenslets were simple spheric GRIN profiles. Later, using the Gen3 printheads with 3-pL droplets, 100-μm-diameter lenslets were made using high order aspheric index distributions.

The flexibility of direct-from-digital inkjet print manufacturing of beamshaping microlenses for external coupling of optical energy, which can be performed directly on PIC wafers, offers the potential for complex 3D optics architectures to be realized that open unprecedented opportunities for developing new integrated systems in photonics and optoelectronics.

This section relates to three-dimensional GRIN microlens arrays for light-field and holographic imaging and displays. The geometric, intensity, and chromatic distortions resulting from the limitations of the material and processes used to fabricate MLAs degrade the performance of light-field systems. To address these limitations, for the first time, inkjet print additive manufacturing is used to fabricate planar GRIN lenslet arrays in which volumetric index patterns embed optical functions that would otherwise require multiple MLA surfaces. Furthermore, by tailoring the feedstocks relative refractive index spectra, independent control over dispersion is achieved and achromatic performance is made possible.

Digital manufacturing is shown beneficial for optimizing individual micro-optical channels in arrays wherein the shape, size, aspect ratio, focal length, and optical-axis orientation of the lenslets vary as a function of the position within the optical field. Print fabrication also allows opaque inter-lens baffling and aperture stops that reduce inter-channel crosstalk, improve resolution, and enhance contrast. These benefits are demonstrated in a light-field display testbed.

A MLA is a key optical element for light-field systems; it plays an important role in capturing and displaying radiance as a function of position and direction in freespace, allowing for accurate and efficient light-field reproduction.

Microlenses refer to tiny lenses with an aperture between tens of microns and several millimeters. An MLA is an array formed when these tiny lenses are arranged on a substrate in a certain order. In addition to converging or diverging the light in the optical system, as do traditional lenses, MLAs have numerous and diverse applications. In addition to light-field imaging and display application, they are employed for coupling light to optical fibers, implementing multi-port optical communications, enhancing the light collection ability of imaging arrays, implementing multichannel imaging systems, and realizing compound eyes.

For all these applications, scalable, low-cost MLA fabrication methods are required that can maintain the parametric control required to accurately implement complex optical functions over a large area, with high quality, and good uniformity. However, using existing manufacturing methods, it is difficult to control the geometric structure, accuracy, and uniformity of the microlenses due to the processing time, pressure, temperature, and wettability that affect the processing process.

As a result, present MLA elements have relatively low surface smoothness, and their shape and focal length are difficult to control. Also, as many MLA fabricated methods are optimized for forming circular lens structures, there is a resulting gap between lenses which degrades the optical fill factor. While rectangular and hexagonal lens arrangements have fill factors that can approach 100%, they require more complex manufacturing methods.

It has recently been demonstrated that drop-on-demand inkjet print additive manufacturing can be used to fabricate three-dimensional (3D) gradient index (GRIN) optics. Unlike a traditional lens, a GRIN lens affects the optical path by varying the index of refraction within the lens itself. Using inkjet printing, planar optics can be made that implement index gradients that range in complexity from simple spheric or aspheric radially symmetric index distributions, to higher order polynomial index distributions that vary as a function of both the radial and axial dimensions, and to complex freeform distributions, in which the index distributions have no axis of symmetry.

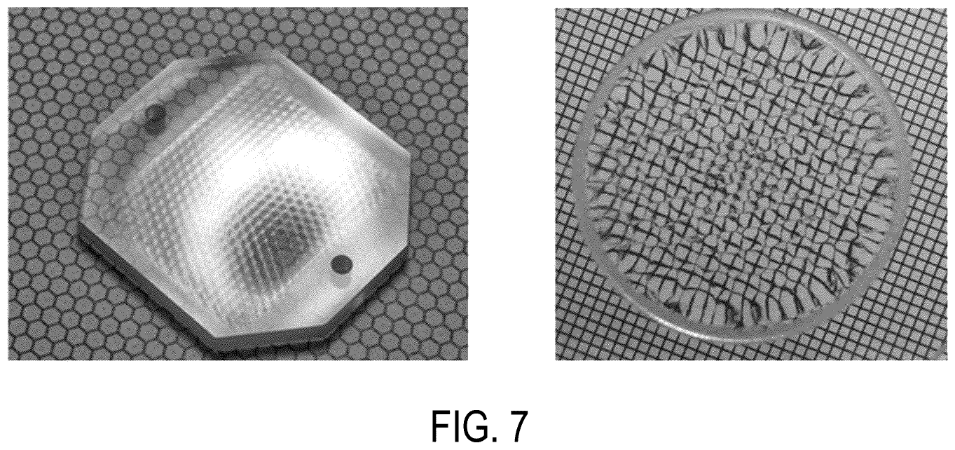

FIG. 7 shows aspects of an example hex-packed hogel lenslet array with integrated mounting features—viz., (left) lenslet with orientation position-variant focal length, and (right) chirped anamorphic lenslet channels.

This disclosure demonstrates performance benefits of additively manufactured GRIN lenslet arrays (e.g., see FIG. 7) and evidence these benefits in light-field applications. While light-field imaging and display are often treated as separate areas, at a conceptual level they are closely related. Display can be simply viewed as the reverse path of imaging, and this perspective is useful for analyzing the role micro-optics play in modulating lightfields and for optimizing the spatial and angular information available in light-field applications.

To demonstrate how the increased degrees of freedom of additively-manufacturing can be used to overcome the limitations of conventional MLAs, a series of GRIN lenslet arrays were designed, inkjet-print fabricated, and characterized. The variety of GRIN MLAs included plano-plano optical elements composed of various sized and shaped lenslets. In these lenslet designs, 3D refractive index profiles were used to implement both optical power and geometric aberration correction, thereby integrating the functional equivalent of multiple surface-figured homogeneous index microlenses, without the need for fabricating and aligning two separate MLAs.

The variety of inkjet print fabricated lenslet arrays also included chirped and foveated designs, in which each individual micro-optical channel has a size, shape (round, square, hexagonal, etc.), aspect ratio (anamorphic, ellipsoidal, etc.), optical-axis orientation, or focal length that is optimized for its position within the array. These characteristics make it possible to image or display objects with different resolutions or perspectives across the field of view. As each channel may be designed to be under normal incidence, off-axis aberrations such as astigmatism, field curvature, coma or other distortions can be reduced. Channel-wise optimization of micro-lens array (MLA) elements is highly beneficial for addressing field curvature and minimizing vignetting. This enhancement facilitates more effective integration with flat, planar image sensors or displays, and may also improve coupling with the human eye.

Moreover, due to the limited material properties, traditional MLAs are susceptible to chromatic aberrations. The ability to tailor the refractive index spectra of the optical feedstock used to print lenslets, makes it possible to create index gradients, with independent control over primary-dispersion and partial-dispersion, making achromatic lenslet performance that would otherwise require doublet or triplets in typical glass optics, and is generally not possible in molded plastic micro-optical elements.

A further benefit of inkjet print additive manufacturing is the ability to simultaneously print multiple types of materials. This makes it possible to monolithically integrate aperture stops and inter-lenslet baffles. In lenslet arrays, this unique feature is beneficial in that it can minimize inter-channel crosstalk and thereby increase the resolution and contrast of multi-channel systems, compound micro-optical arrays, and micro-optical telescope arrays, especially when used in wide field of view applications.

The insight offered by plenoptic function and light-field theories reveals that the light-field can be generated based on either light ray or wavefront reconstruction, with the latter known as holography. Lightfields provide a natural way of representing information that is captured and processed by the human visual system. If a light-field represents the radiance in a real scene that is visible to the human eye, then a display that provides a light-field with those depth cues, should create the same sensation as looking at the real world.

While duplicating a complete light-field is not possible, a practical approach is to subsample the continuously distributed light-field function and then use a finite number of ‘views’ to approximate the light-field function. Despite the taxonomic difference between multi-view displays, plenoptic displays, and integral imaging displays, the general structure of the image plane is a composite multi-view image that consists of repeated image cells. Each cell of the composite image has small patches representing different parallaxes. The elements that form 3D display images, often called voxels (volumetric picture elements) or hogels (holographic picture elements), therefore must emit directionally varying light. The greater the amount and accuracy of the view information that is presented to the viewer, without distortion, the more the 3D display appears like a physical object.

However, due to the tradeoff of spatial bandwidth with depth and perspective bandwidth, to date, there has not been geometric-optic based 3D displays that approximate the continuous light-field function adequately for realistic 3D information display.

While light-field optical system implementations differ considerably, MLAs plays a key role in the spatio-angular design tradeoffs required for light-field system optimization. For example, in light-field displays, elemental cells are created using the addressable pixels of an OLED or LCD panel to modulate light, which is channeled through the MLA to create angularly separated views that approximate the directional beams of light emitted from real objects. In this role, to accurately recreate realistic 3D images and to avoid light-field information loss and distortion, the MLAs should: 1) minimize crosstalk and ghost images to confine the emerging light within a well-defined region; 2) have precise shape, size, and focal length lenslets, and lattice sampling scheme, to provide correct vergence and accommodation cues; 3) precisely manipulate light over a large field-of-view; 4) have high light efficiency, and 5) maintain a thin form factor and be lightweight.

A challenge of optimizing traditional MLA designs is the limited number of available fabrication methods. In bulk optics, mechanical machining is a most universal method for generating complex, smooth, and successive optical profiles with the desired shape. But at the millimeter scale, and below, fabrication is more challenging. Moreover, mechanical fabrication methods are generally not cost-effective or sufficiently scalable for MLA applications.

The most used physical and chemical methods for fabricating MLAs are direct fabrication methods that include photoresist reflow, gray scale lithography, photolithographic ion exchange technology, microplastic embossing, microdroplet jetting, etc. However, with these techniques, the types of materials available to make microlenses are limited. Also, due to the complex processes used in direct fabrication methods, it is difficult to control the lenslet radius of curvature (RoC), to achieve high fill factor, and to fabricate tightly packed lenslet arrays.

More recently, stereolithographic printing techniques have been adopted for use in the fabrication of micro-optics with complex profiles. Although the process is superior to other fabrication methods for use in prototyping, the low production efficiency and limited working dimension impedes its wider applications in optical manufacturing, especially in large-area micro-optics. The dispersion properties of compatible materials also make chromatic aberrations a problem. Therefore, these methods are most often used to create one-off prototypes or limited production molds for use in indirect fabrication.

Indirect fabrication methods are those that manufacture using replication. Because metallic molds must be made using ultra-precision machining, most molding methods are expensive. The most cost-effective indirect fabrication techniques use polymer materials along with hot embossing or UV molding replication techniques. In addition to the limited types of materials available with these methods, one of the biggest challenges is to reproducibly achieve the high surface-coverage ratio necessary for lower optical loss and higher focusing efficiency. The material property limitations, combined with process complexity, restricts the complexity of allowable lenslet shapes and limits replication at industrial scales.

Owing to limited precision and the available manufacturing process tolerances, especially at the small geometric scales required for light-field applications, errors are introduced into the MLAs. In conventional MLAs, this occurs primarily as the shape error between the actual surface and the ideal face shape, which causes sag, irregular deformation, change in curvature radius, coordinate distortion and other defects, which may vary at different locations of the array. Combined with assembly alignment mismatches, these defects lead to blurring, vignetting, aliasing, distortion, and other degradation of the light-field information. Also, due to the refractive index spectra of the materials, chromatic aberrations are inherent to these MLA types.

NanoVox has developed a flexible, ink-jet print additive manufacturing platform for on-demand manufacture of gradient index (GRIN) micro-optical elements. By varying the properties of multiple primary optical feedstocks as they are printed, it is possible to create complex refractive index gradients within the bulk of an optical element.

An inkjet printer for manufacturing optics may have a one-meter print bed that can be configured for roll-to-roll fabrication. This print platform is used to print GRIN elements sized from below 100-micron scale to more than 35-centimeters. In this example, the planar array being printed has a linear dimension of 7.5 inches and is optimized for a high fill factor by circumscribing the hexagonal lenslets within the circular GRIN distribution.

In 3D GRIN materials, the refractive index may vary in up to three spatial dimensions, n(x, y, z). This allows, for example, implementation of spheric and aspheric 3D GRIN functions that may vary as a function of their position along the optical axis. These added degrees of freedom allow a single plane-parallel 3D GRIN optic to replace multiple lens surfaces, eliminating the need to fabricate, align, and bond multiple homogeneous index lens elements.

The flexibility of the inkjet fabrication process allows complex freeform GRIN optics to be fabricated, including MLAs in which there are no axis of symmetry throughout the array. Because print fabrication proceeds directly from digital design files, it lends itself well for customizing the size, shape, and orientation of each optical channel of an array. The inherent ability of 3D printing to register layers makes inkjet printing well suited for fabricating compound micro-optical arrays, micro-telescope arrays, artificial compound eyes, etc.

A further benefit of multi-material inkjet print manufacturing is that is it readily allows for lens arrays to be fabricated that have integrated opaque baffles, edge-blackening, and aperture stops, as well as fiducial marks, mechanical mounting structures, and alignment holes. An example of an inkjet-printed MLA, optimized for high fill factor using hexagonal lenslets, that is monolithically integrated with mounting features, is shown in FIG. 7, left.

Inkjet print fabrication is compatible with a range of feedstock materials, which makes it well suited for correcting chromatic aberrations. The standard solution to correct axial color aberrations is to replace a homogeneous singlet with a doublet composed of two different materials with different Abbe numbers. However, when using inkjet print fabrication, it is possible to formulate nanocomposite optical inks with specific index, dispersion, and secondary color properties. The refractive index spectra of nanocomposite inks are tailored by embedding various concentrations of one or more types of organic or inorganic nanoparticles in blends of low-viscosity photocuring monomers. By selecting material sets with complementary refractive index spectra, it is possible to create index gradients with independent control over dispersion and, as a result, manufacture achromatic GRIN singlets.

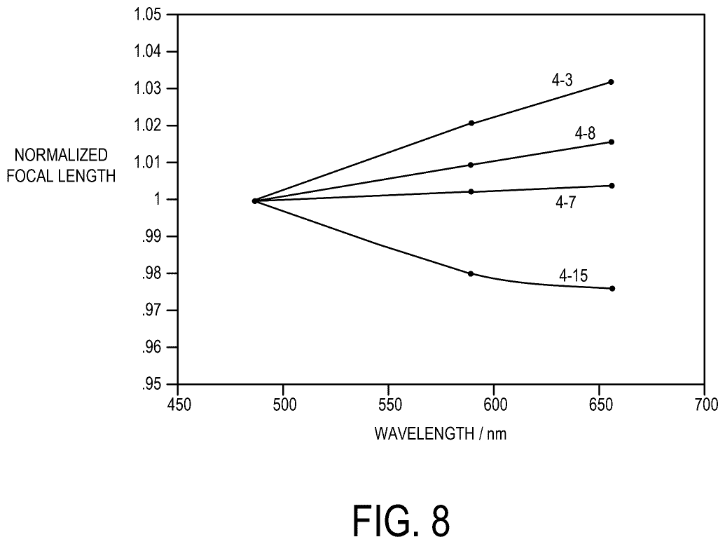

FIG. 8 shows a graph of the average focal length measurements obtained from a 35-mm by 45-mm area, seven-by-eleven element array of 4-mm-diameter, radially-symmetric GRIN lenslet elements on a 5-mm pitch. Here, the normalized focal length measurements of 4-mm spheric radial GRIN lenses are made by mixing the number referenced binary optical ink pairs, each including a common high index ink. Independent control over the gradient index and dispersion is shown. Each lenslet array was fabricated using binary primary optical ink pair, which shared a common high-index optical ink, i.e., Ink 4. The positive GRIN lenses were fabricated with the same spherical GRIN profile, n(r)=n₀−Δn (0.25)r², where no is the highest index of the pair, Δn is the difference between the high index and the low index inks, and r is the radius referenced from the optical axis through the center of the lens. The data in FIG. 8 share a common normalized focal point at the short wavelength. The focal length measurements show that by changing the composition of one of the primary optical inks used to fabricate the GRIN lenslets, it is possible to obtain positive (ink pairs 4-3 and 4-8), negative (ink pair 4-15), and neutral (ink pair 4-8) dispersion. The GRIN lenslet elements fabricated using the binary ink pair 4-7 shows achromatic behavior, as the focal lengths at the three wavelengths are nearly the same, because the Δn(λ) is about the same for all wavelengths.

To demonstrate the benefits of structured-freeform refractive 3D GRIN optics, including those with precise dispersion, a series of 3D GRIN lenslet arrays are optimized for light-field and holographic display applications.

A design study was performed to compare monolithic GRIN hogel array designs with a state-of-the-art (SOA) compound hogel array comprised of two precisely aligned polycarbonate MLAs. In this study, the design objectives were to achieve a sufficiently small spot size to accommodate a one-meter viewing range at angles more than +/−300 from normal, with high light transmission. The hogel size was restricted to 0.526 mm, and the rays from the display entered the lenslet elements at angles up to 60°, which makes it challenging for MLAs to structure tight beams distributed over a large field of view.

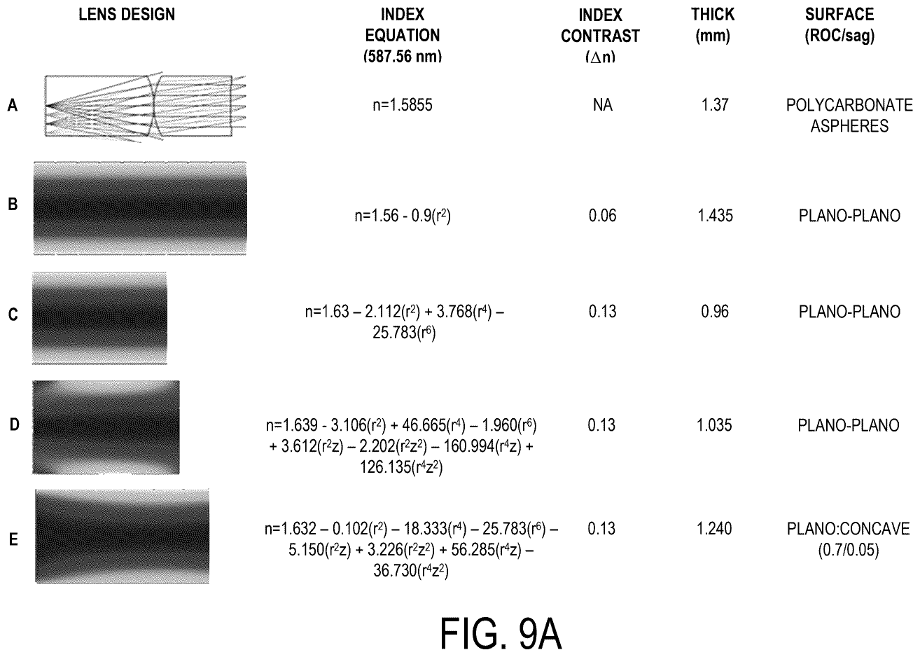

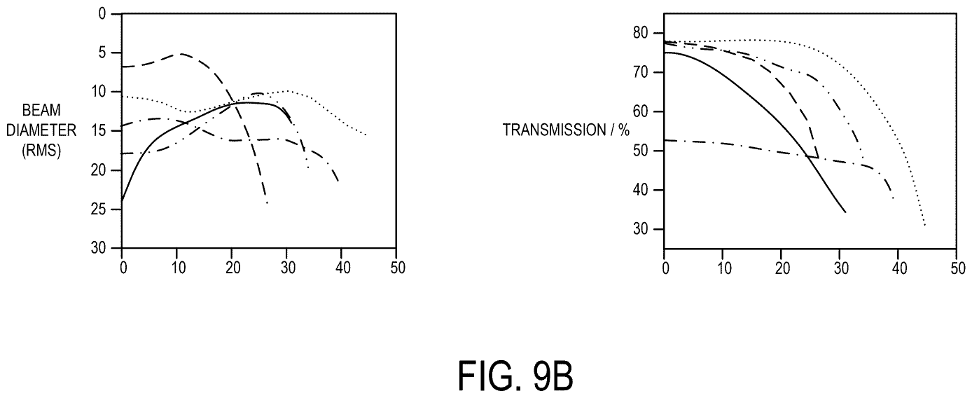

Shown in FIG. 9A are the series of micro-optical designs. The five designs include the SOA polycarbonate two-element MLA pair (‘Design A’) and four different GRIN lenslet designs, which have increasing degrees of design freedom. The commercial SOA polycarbonate (PC) lens stack includes primary and secondary MLA elements, both with 6th order aspheric surfaces, which are bonded using index matched epoxies. The optical centers must align to better than +/−5 μm to avoid performance degradation. Also, polycarbonate has an Abbe number of v_{d}=29.9, which makes chromatic aberrations a challenge with this design.

Designs B, C, and D are plano-plano gradient index lenslet designs. Design B is comprised of a simple radially symmetric spheric (i.e., r²) GRIN profile, which is implemented with materials characterized by a total refractive index contrast Δn=0.06. Design C has a radially symmetric aspheric (i.e., up to r⁶) GRIN profile, and Design D has a 3D GRIN profile in which the index gradients change both axially and radially. Both Design C and Design D use nanocomposite materials with a refractive index difference of Δn=0.13.

Lastly, Design E is a hybrid plano-convex design, in which the 3D GRIN profile is augmented with optical power from a convex surface lens with a ROC=0.701 mm and 0.05-mm sag. In these hybrid designs, the 3D GRIN profiles pre-distort the wavefronts to compensate for geometric aberrations induced by the surface lens shape so that they are emitted with the desired beam shape.

Shown in FIG. 9B are the RMS beam sizes at a one-meter viewing distance plotted as a function of the viewing angle, whereby a 0° viewing angle is normal to the display. The drawing shows the beam diameter at one-meter distance (left) and transmission (right) over the range of viewing angles (positive and negative) from normal for four GRIN designs compared to state. In these plots the solid line represents Design A (SOA two-part MLA); the dashed line represents Design B (spheric (r\hat{ }2) radial index distribution); the dot-dashed line represents Design C (aspheric (r\hat{ }i, i=2, 4, 6)); the double-dot dashed line represents Design D (radial and axial GRIN (r\hat{ }i, i=2, 4, 6); radial (z\hat{ }j, j=0, 1, 2)); and the dotted line represents Design E (radial and axial GRIN (r\hat{ }i, i=2, 4, 6); radial (z\hat{ }j, j=0, 1, 2) with concave spheric radius surface). The beam size projected from the SOA polycarbonate MLA pair (Design A) is large at a normal (i.e., 0°) viewing angle, and the beam diameter changes significantly over the range of viewing angles. The smallest beam diameter, about 12-mm, is achieved at viewing angles between 20° and 30° from normal; the total field of view is about 60°.

Design B, which is implemented with only the simple radially symmetric spheric GRIN distribution, is able to achieve a smaller beam diameter at a normal viewing angle than Design A, but the range of viewing angles is smaller. The beam diameters of Design C, which is comprised of higher order (i.e., up to 6th) aspheric GRIN terms, is about 40% smaller in diameter at a normal viewing angle, than Design A. Also, a more uniform resolution beam resolution is obtained over an almost 80° field of view. Design C transmits about 183% more light-field information than Design A, as defined by the number of display rays transmitted per hogel. It is also about 30% shorter in length.

Design D has a more complex 3D gradient index distribution than the previous designs. The gradient index cross-terms (i.e., those gradients that that vary both axially and radially) are useful for reducing geometric aberrations including spherical and coma contributions. The added degrees of freedom provided by both radial and axial gradient index profiles also enable such designs to have a tighter beam size over a wider field of view, which can be used to capture more of the rays from the display and concentrate them into smaller transmitted beams.

In Design D, the spot size is about 30% smaller at a normal viewing angle and good spot size resolution is obtained over a 70° total field of view. At the limits of the viewing angles, the transmission is about 60% higher than Design A.

The data from these three GRIN designs supports the assertion that the added degrees of freedom afforded by monolithic plano-plano GRIN elements allow them to replace multiple conventional surfaced homogeneous lenses, without the need for opto-mechanical alignment and stabilization.

Further degrees of freedom are added in Lenslet E, wherein the optical functions provided by 3D GRIN profiles are augmented by optical power from a surface figure. With the addition of a printed concave surface lens, Lenslet E has good spot size resolution and high transmission over more than a 90° field of view. This design transmits about 330% more light-field information than Design A.

Using the design trade study as a baseline, a 3D GRIN MLA was designed for use in a light-field display being developed by Holochip Corporation (Torrance, CA; USA). Holochip's 29.491 million pixel RGB light-field display is comprised of a 2×4 tiled array of 1440×2560-pixel LCD displays. The LCD pixel pitch is 47.25 microns (approximately 538 PPI) and each gradient-index-lenslet hogel element is approximately 16 pixels in diameter, which results in a resolution of approximately 256 individual pixels per hogel.

To match the MLA size to the specified LED display tile format, a 90×160 element GRIN lenslet arrays was developed with 756 μm pitch elements, arranged in square packing. The 756 μm pitch hogel size is larger than the 526 μm pitch used in the above design study. With a back focal length (BFL) of BFL=0.345 mm, the goal is to project the individual display pixels in a 10-mm spot size, or smaller, at 1-meter range, over more than a +/−23° FOV.

For this specification, a 3D GRIN lenslet design was optimized, which can be described by an index distribution:

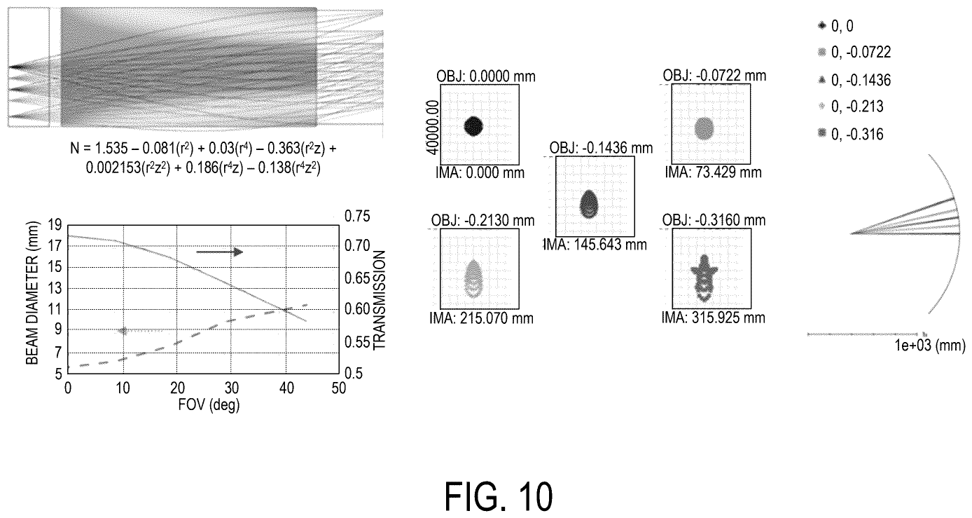

n=1.535−0.081(r²)+0.03(r⁴)−0.363(r²z)+0.002153(r²z²)+0.186(r⁴z)−0.138(r⁴z²),

where r is the radial dimension and z is the axial dimension. FIG. 1 shows aspects of a 3D GRIN hogel lenslet configuration—viz., showing beam diameter and transmission as a function of field of view and a spot diagram at 1-meter shown at various viewing angles. The gradient index design, represented in the false color image of FIG. 10 (upper left), was implemented with a refractive index contrast of Δn=0.0971. Each lenslet element is 1.65-mm thick.

The projected spot shapes over the field, at a 1-meter viewing distance, are shown in FIG. 10 (middle). The spot size and transmission, as a function of the viewing angle, are shown in FIG. 10 (lower left); a 10-mm spot size is obtained over a +/−30° FOV at one-meter viewing distance, and a spot size smaller than 12 mm, smaller than the average human interocular distance, is obtained to about +/−45° FOV.

For simplicity, the gradient index profiles were fabricated using a binary primary optical ink pair. NanoVox model VZBXX070 “high index” ink (n=1.52) and model VYBXX010 “low index ink” (n=1.38) were selected. Using binary print composition, the two index inks are blended on the substrate, using ‘print composition’ to mix the two inks in different ratios to create the intermediate index values of the gradient profiles. Using a method conceptually like the halftoning processes used in the graphics industry, a bitmap was created that specified the specific deposition locations for the concentration of droplets for each ink. The bi-level patterns are optimized to promote mixing and inter-diffusion of the two inks so that sub-wavelength accurate, smooth gradient index patterns are produced after polymerization.

A series of MLA elements were fabricated using the customized 600 dpi (42-μm resolution) inkjet graphics printer. For this design, a challenge of using a such a low resolution (i.e., 22 pl. drop) printer is that the 756-μm linear dimension of the gradient profiles is comprised of only about 18 droplets, and the entire two-dimensional area of the GRIN profile is created using a total of about 324 droplets per layer. Due to the perimeter-to-area ratio of the square elements, at this print resolution 22% of the droplets are in contact with the edges of the hogel element, where they are susceptible to influences from the neighboring lenslet GRIN patterns.

Not surprisingly, finer resolution printing enables better control over the index gradient shapes. For example, when configured for 0.25 pL drops, which create a 5.29-micron diameter spot, a 4800-dpi resolution printer has about 64 times better resolution and has proportionally more degrees of control for creating the gradient profiles described above. Also, the amount of material printed in contact with the hogel border is reduced to 2.75%, which makes it easier to accurately reproduce the gradient index profile designs. Moreover, printing using multi-level (e.g., tri-level, etc.) halftoning, because less diffusion is required to achieve the desired mix, makes it easier to create sub-wavelength precise gradient profiles. Nevertheless, a printer configured for 600 dpi resolution is sufficient for fabricating high quality optics for this application.

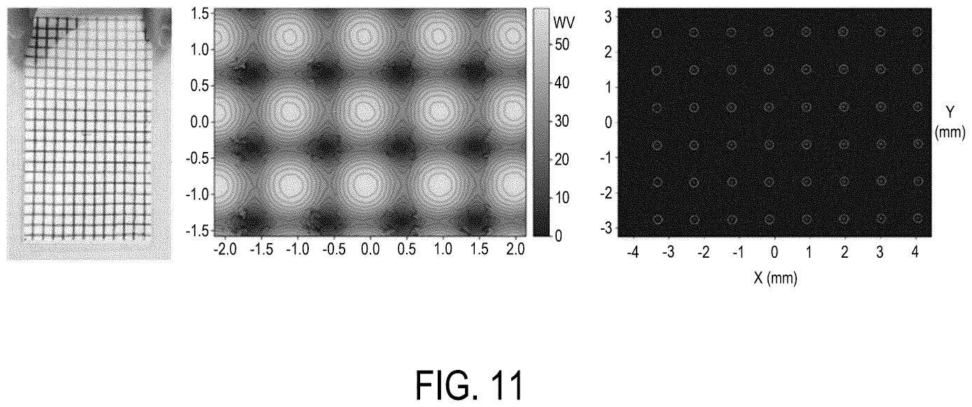

FIG. 11 shows photographs of a 68-mm×121-mm, 90×160 element, hogel array showing the projected picture of underlying graph paper—viz., (left) the optical path difference plots measured using a digital holographic microscope (DHM) plotted at the exit of the hogel array (middle) and at the focal plane (right), showing good uniformity. FIG. 11 (left) shows a photograph of one of the fabricated 90×160 element (5.7-inch diagonal) tiles. In the specific lenslet array shown in FIG. 11 (left), no inter-lenslet baffles were printed, and the photograph shows a projected image from underlying graph paper. The images of the lenslet elements of the arrays showed good uniformity and low distortion. The average back focal length measured across the array was 3.996 mm; the standard deviation was +/−0.046-mm (1.15%).

Shown in FIG. 11 (middle) is the measured wavefront profile at the exit plane of the lenslet array. The wavefront profile was generated from optical path difference (OPD) measurements made using a custom-built digital homographic microscope (DHM). The wavefront profiles have good optical quality and uniformity. The wavefront profiles show only modest interaction with the adjacent hogel elements at the borders. Shown in FIG. 11 (right) is the location of the focal spots showing good uniformity across the array. Compared to conventional MLAs with micro-optical elements of this size, high optical quality was observed.

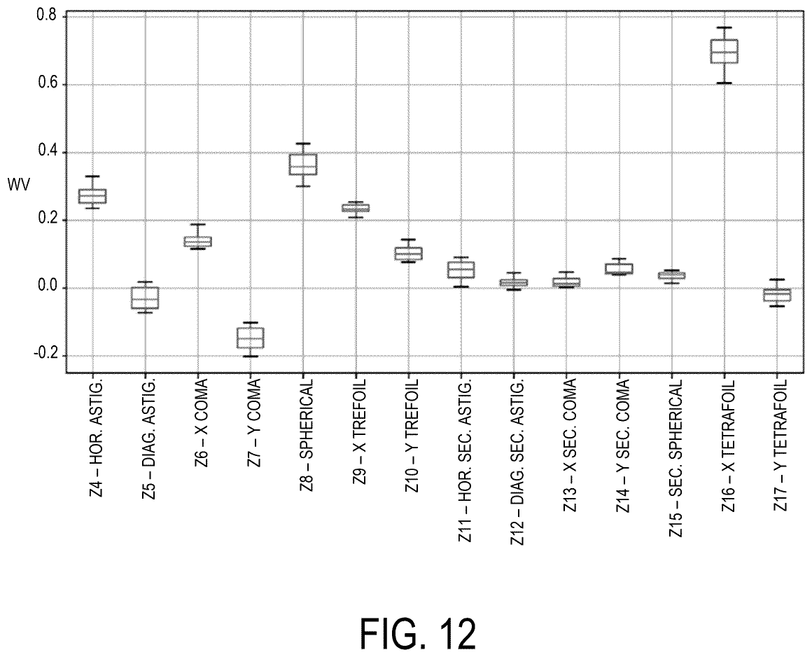

FIG. 12 shows Zernike polynomial fitting of the wavefront error (WFE)—viz., a Zernike polynomial fit of wavefront error showing Z4 through Z17 contributions. The Zernike polynomials are a set of functions that are orthogonal over the unit circle. When the Zernike polynomials are fit to a spheric wavefront, the deviation due to wavefront aberrations in the optic can be diagnosed. The wavefront error of these printed parts was dominated by tetrafoil (Z16), spherical (Z8), horizontal astigmatism (Z4), and trefoil (Z9). The angular orientation of the wavefront errors, indicated by the magnitude of the Z16 error compared to that of the Z17 error, confirms that the contributions of these higher radial order polynomial WFE are located at the border with the neighboring lenslets (see FIG. 11 middle). At the locations where the circular GRIN profiles meet at the square-packed lenslet interfaces, the slopes of the index gradients reverse direction as they enter into the adjacent lenslet elements. Border effects are common for most types of MLAs, which is why it is common for clear apertures of about 90% to be specified.

However, for printed GRIN MLAS there are straightforward improvements that can be made that do not compromise the fill-factor. Lower wavefront errors are obtained if the shape of the transition is made sharper, which can be accomplished using finer resolution droplets. Also, the higher frequency gradient transitions can be preserved by refining the print patterns such that less inter-diffusion of constituents from the neighboring elements occurs in these regions. Similarly, the spherical aberration, Z8, and trefoil, Z9, may be reduced by compensating the print map patterns, such that when the droplets from each ink are deposited, inter-diffused, and cured, they better reproduce the gradient index patterns. The horizontal astigmatism, Z4, can be controlled by changing the printer alignment and curing parameters.

A simple, but non optimal, way to correct the print maps is to add or substrate the Zernike coefficients fitted to the WFE from the print maps. More sophisticated methods can be used to pre-compensate the print maps using models of the diffusion effects. Nevertheless, in these parts, the print patterns or process parameters were not further refined.

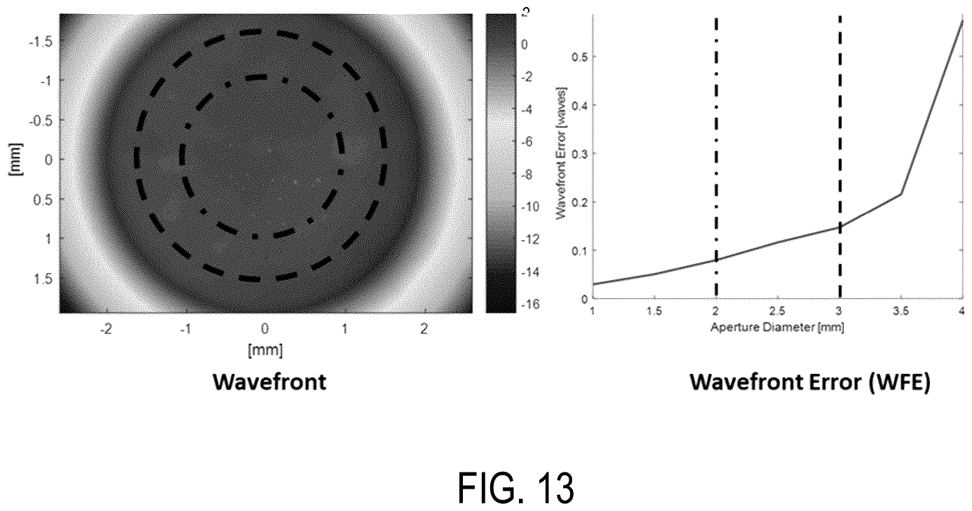

To demonstrate the extent that borders contribute to wavefront errors an array of 4-mm-diameter parabolic radial index functions (f/19) were printed on a square packed grid, and the DHM was used to measure WFE over a series of clear apertures. The analysis of FIG. 13 shows the contribution of WFE as a function of the clear aperture. FIG. 13 shows aspects of a measured wavefront—viz., and wavefront error as a function of the clear aperture of a 4-mm lenslet from an array. The WFE is below λ/10 within the central 2.3-mm diameter clear aperture, and it is λ/5 within the central 3.5-mm diameter clear aperture. The WFE increases at the outer edges of the distribution that is adjacent to the edge of the hogel elements.

As suggested above, there are ways to improve the WFE at the edges of the elements without having to define a smaller clear aperture or decrease fill factor. In addition to using a higher resolution printer, which allows better reproduction of the parabolic distribution near the edges of the element, it is also possible to develop ink drop patterns that compensate for the interfacial effects. Similarly, aberrations may be further reduced using more precise inter-layer alignment, using multi-level halftoning, and by developing bitmap patterns that compensate deviations in shape caused by diffusion.

To further reduce crosstalk and improve FOV, the materials and processes necessary to print baffles, borders, and aperture stops were developed. First, optically opaque (‘black’) inks were developed with the rheological properties necessary for reliable inkjet printing. The black ink was optimized so that that it was compatible with the NanoVox optical inks, would not diffuse into the optically transparent area, and would not cause the refractive index profiles to distort at their edges in contact with the baffles.

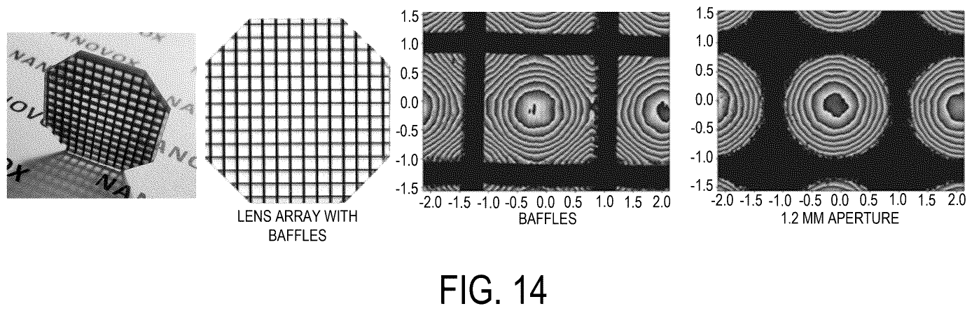

Processes were developed for printing different types of baffles, including those that were: located only at the surface, located in only a portion of the optic thickness, and extended through the entire of the optical element. For the 600-dpi printer, when extended through the entire thickness of the lens array, the printed baffles were 120 μm wide. This border thickness may eventually be reduced to the 40 μm resolution of this printer, but those efforts were not continued within this effort. Pictures of the test MLA, with baffles extending through the entire MLA thickness, are shown in FIG. 14. FIG. 14 shows photographs of an inkjet-printed lenslet array with baffle that extend through optical element defining the borders of each optical channel. They absorbed 99% of incident light over the relevant range of angles.

A single LCD module of the Holochip-tiled light-field display is configured with three different MLAs. The display tiles were first implemented with a molded plastic lens array, FresnelTech model 630 (FIG. 29, left), which was capable of a full viewing angle of only 32°. Beyond a 16° angle from normal, unwanted display of information due to cross talk with neighboring hogel elements was evidenced. When the light-field test bed was configured with 3D GRIN lenslet arrays (FIG. 14, middle) a 48° FOV was achieved. When the MLAs were configured with inter-lenslet baffles (FIG. 29, right) a 120° FOV was possible without crosstalk.

The 3D GRIN lenslet arrays with baffles were used to configure a 4×2 panel array that was used to create the light-field display.

Additive manufacturing allows for straightforward implementation of additional degrees of freedom whereby the size, shape, aspect ratio, focal length, and optical axis orientation can be varied as a function of the lenslet position within the optical field (e.g., see FIG. 7, right) to allow the optical functions of each individual optical channel to be optimized for the specific application, such as projecting curved Petzval surfaces onto planes,

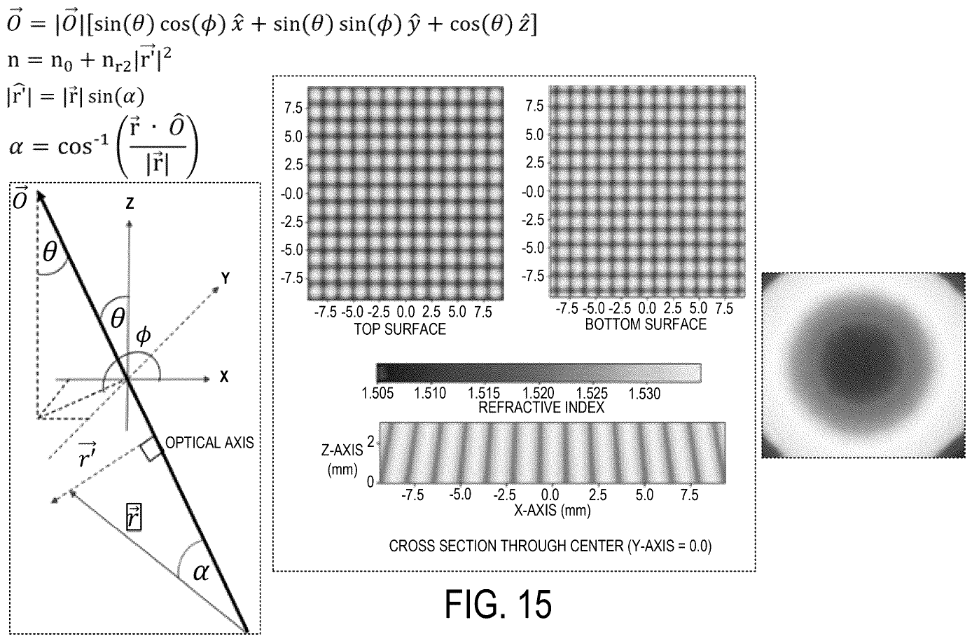

FIG. 15 shows a lenslet array design developed for a head-mounted light-field display application, where the GRIN profiles vary as a function of the lenslet's position within the array. The drawing shows the radially symmetric GRIN hogel lenslet array (middle), wherein the optical axis orientation of each GRIN profiles varies was a function of its location in the array relative to the common focal point at 42.5 mm (as described on the left). The wavefront profiles of the lenslets measured of elements across the x-dimension of the array through the center of the device (i.e., y=0.0), showing the optical path differences due to tilt are shown on right [Visualization E]. The spheric-radially symmetric GRIN profile is shown FIG. 15; n₀=1.535, nᵣ₂=−0.029, and the radial vector is defined by the geometry of the lenslet relative to its position in the array relative to focal point on optical axis. Each radial lenslet is located in a 1.728-mm pitch square grid, and the lenslet optical axis are tilted such that they have a common focal point at 42.5 mm. The lenslets were tested by analyzing the wavefronts across the array using DHM measurements. The wavefront profiles across the x dimension of the array, at position y=0.0, are shown in FIG. 15 (right).

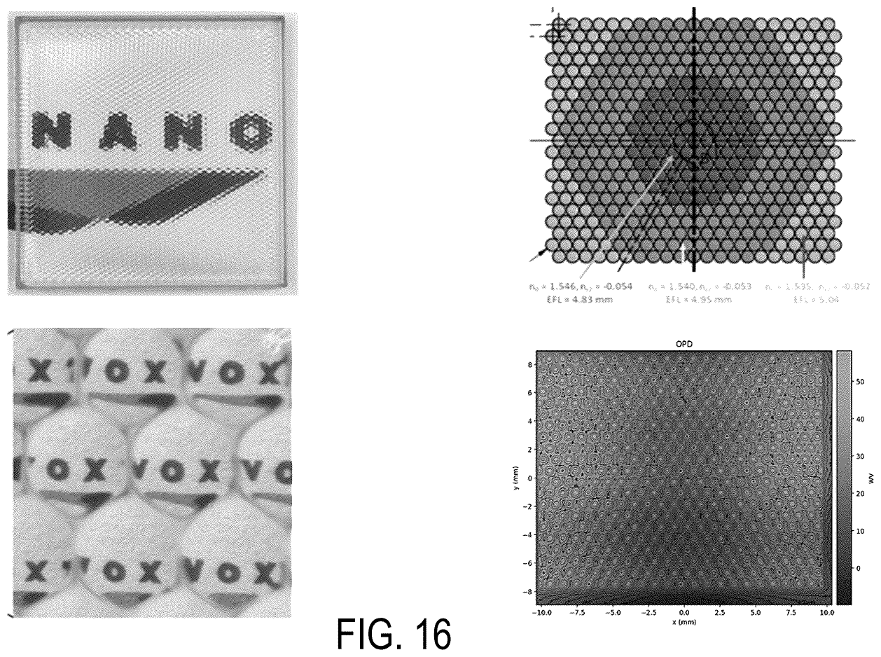

A series of lenslet arrays composed of lenslets with variable focal lengths were fabricated. An example of a 2-mm thick. variable focus lenslet array, composed of radially symmetric GRIN lenslets configured in a hexagonal packing scheme is shown in FIG. 16 (upper left) The array is composed with regions have different radial GRIN functions, n=n₀+nᵣ₂r² that create zones with different focal lengths. FIG. 16 shows aspects of a variable focus lenslet array—viz., including round GRIN lenslets in a hex packing (pictured lower left). The array is configured with zones containing three different focal lengths (upper left). The measured wavefronts across the array are shown (lower right). The three different designs that the following coefficients [n₀=1.566, nᵣ₂=−0.054], [n₀=1.540, nᵣ₂=−0.053], and [n₀=1.535, nᵣ₂=−0.052], designed to achieve focal lengths of 4.83 mm, 4.95 mm, and 5.04 mm. The efficient hexagonal packing of the radially symmetric lenslets is shown in FIG. 16 (lower left). The wavefront measurements obtained by measuring the optical path differences using the custom DHM is shown in FIG. 16 (lower right)

The processes necessary for monolithically printing homogeneous surface lenses on top of the GRIN lenslets were also developed. Images of underlying graph paper obtained through 4-mm diagonal GRIN lenslets printed with and without co-registered convex surfaces. The compound lenslets on the right side of the picture, included 60.8 mm ROC lenses with a 25.1 mm sag, and had a measured focal length of 58 mm, whereby the GRIN (only) lenslets had a focal length of 100 mm. Shown in the middle are an array of printed 500 micron diameter homogeneous lenses. Shown in the right of is a printed 750-micron ROC concave lens, with a measured SAG of +1 μm.

For the first time, measured performance of inkjet print additive manufactured gradient index lenslet arrays was demonstrated. The flexibility of digital additive manufacturing allows for complex structured freeform GRIN devices, such as MLA arrays to be designed and built without the need for expensive tooling, facilitating quick design-and-build cycles and enabling rapid innovation.

It was shown that the degrees of freedom afforded by plano-plano 3D GRIN lenslets enable them to implement the optical functions of multiple surfaced homogeneous index optical elements. The ability to monolithically augment the 3D GRIN performance with a surface shape, further expands the degrees of freedom and allows complex compound optical functions to be monolithically implemented. The additional degrees of freedom provided by nanocomposite materials allow for independent control over dispersion, which also enables achromatic performance to be achieved in lenslets. These benefits combine to allow GRIN lenslet arrays to be made that have reduced aberrations and that eliminate the need for compound lens designs and the concomitant need for precise optical alignment and opto-mechanical stabilization.

The performance measured on fabricated GRIN MLA optics was superior to state-of-the-art molded polycarbonate MLA optics, including stacked MLA devices, as was demonstrated in light-field display applications. The ability for additive manufacturing to implement baffles between optical channels was shown beneficial for reducing crosstalk and improving resolution.

The flexibility of direct-from-digital bottom-up additive manufacturing was evident in the variety of GRIN MLA lenslet shapes, sizes, and lattice-packing schemes, which included chirped and other position-dependent lenslet designs, in which each channel's size, shape, optical-axis-orientation and aspect ratios were to optimize the array for implementation in specific optical system designs. The demonstrated ability to individually optimize each lenslet of the MLA offers significant benefits for a variety of additional applications.

The optics were fabricated with a 600 DPI printer. The use of high throughput of the commercial graphics printers demonstrates that the process is scalable to high volume. Using six printheads, in production, 1-cm format lenses can be printed in less than one minute.

The performance advantages demonstrated here in light-field system applications, suggest GRIN lenslet arrays may benefit communications, micro-vision systems, motion detectors, rangefinders, multi-aperture camera systems, and other optical sensor system applications.

### Section 2

FIG. 17 shows aspects of an example photonic device 102 comprising a photonic integrated circuit 104 and one or more gradient-index optical films 106. Each gradient-index optical film is configured to couple electromagnetic (EM) radiation into or out of the photonic integrated circuit. The wavelength range of the EM radiation is not particularly limited. The EM radiation may comprise ultraviolet, visible, infrared, or radio-frequency radiation. In the illustrated example, among others, photonic device 102 comprises film 106A printed directly on an entry aperture 108. In other examples the film may be printed directly on an exit aperture. Film 106A may be printed directly onto a circuit, wafer, package, or panel, for example. In other examples the film may be configured for coupling the EM radiation into or out of a lightfield or holographic display. In the illustrated example substrate spacer 110 separates film 106A from photonic integrated circuit 104.

In some examples film 106A comprises a cured coalescence of inkjet-printed droplets, as described hereinabove. The droplets may comprise an admixture of two or more nanocomposite materials, for instance, such as optical materials. In some examples film 106A may be overall achromatic, such that the focal lengths at two or more wavelengths of the EM radiation are matched.

In some examples film 106A may further comprise one or more opaque baffles 112 configured to reduce scattering and/or crosstalk between channels.

In some examples film 106A comprises an aspheric refractive-index gradient, wherein the index changes as one or more functions of r\hat{ }x, wherein x is greater than 2. In some examples the film may comprise at least one aspheric refractive-index gradient that changes as a function of position along optical axis 114.

In some examples film 106A may comprise one or more non-radially symmetric optical channels and/or a non-radially-symmetric gradient. The non-radially-symmetric gradient may be optimized to couple light that is being coupled at an axis other than the optical axis of a non-radially-symmetric gradient. Likewise, in some examples film 106A may comprise at least one gradient that couples light from an angle other than the gradient axis. Such a film may comprise a non-radially symmetric gradient wherein the aspect ratio of the gradient is configured to optimize coupling to photonic integrated circuit 104. The gradient may include axis-dependent gradients configured to couple to non-symmetric detectors, or other gradients.

In some examples film 106A may comprise at least one array of microlens, micro-optical and/or lenticular elements, as described hereinabove. The micro-elements can be round, square, rectangular, hexagonal, and/or oval, in some implementations.

In the illustrated example film 106A is planar, but that aspect is not strictly necessary. In some examples film 106A may comprise two or more non-radially symmetric optical channels. The channels may be optimized for coupling light to or from a grating, for instance.

In some examples film 106A is configured to couple light over a wide range of angles in one direction that exceeds to range of angles in another direction.

Film 106A may comprise a gradient-index function optimized for mode matching to a waveguide 116A. For instance, film 106A may be configured to couple the EM radiation orthogonally to or from the surface of photonic integrated circuit 104, even when the emissions from any gratings in the waveguides of the photonic integrated circuit are not orthogonal.

The film may comprise a gradient-index function optimized for beam shaping. For instance, film 106A may be configured to couple a Gaussian beam, a super-Gaussian beam, a Bessel beam, an airy beam, a top-hat beam, a vortex beam, or a Laguerre-Gaussian beam, for instance.

Film 106A may comprise gradient-index functions that are configured to couple different phases of light waves at different points across the film—e.g., for beam steering or optical phased-array emission or detection.

In some examples film 106A is based on a bitmap; the bitmap may optimized via Zernike decomposition of measured wavefront errors, or other wavefront errors, for instance.

This disclosure is presented by way of example and with reference to the attached drawing figures. Components, process steps, and other elements that may be substantially the same in one or more of the figures are identified coordinately and described with minimal repetition. It will be noted, however, that elements identified coordinately may also differ to some degree. It will be further noted that the figures are schematic and generally not drawn to scale. Rather, the various drawing scales, aspect ratios, and numbers of components shown in the figures may be purposely distorted to make certain features or relationships easier to see.

It will be understood that the configurations and/or approaches described herein are exemplary in nature, and that these specific examples are not to be considered in a limiting sense, because numerous variations are possible. The specific routines or methods described herein may represent one or more of any number of processing strategies. As such, various acts illustrated and/or described may be conducted in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A gradient-index optical film configured to couple electromagnetic (EM) radiation into or out of a photonic device, the film comprising:
at least one gradient-index function optimized for mode matching to a waveguide of the photonic device.

2. The film of claim 1 wherein the EM radiation is ultraviolet, visible, infrared, or radio-frequency radiation.

3. The film of claim 1 comprising a cured coalescence of inkjet-printed droplets.

4. The film of claim 3 wherein the droplets comprise two or more nanocomposite materials.

5. The film of claim 4 wherein the film is achromatic such that the focal lengths at two or more wavelengths of the EM radiation are matched.

6. The film of claim 1 comprising two or more optical elements configured in an array of microlens or lenticular elements.

7. The film of claim 6, wherein the optical elements are configured with optical phase modulators to effectively control light for beam steering and shaping.

8. The film of claim 1 wherein the film is planar.

9. The film of claim 1 comprising at least one aspheric gradient, wherein the gradient has a polynomial form with power greater than two (r\hat{ }x, x>2) in at least one dimension

10. The film of claim 1 comprising at least one gradient that changes its radial distribution as a function of the position along an optical axis.

11. The film of claim 1 comprising at least one non-radially symmetric optical channels.

12. The film of claim 1 comprising at least one round, square, rectangular, hexagonal, and/or oval shaped micro-optical elements.

13. The film of claim 1 further comprising one or more opaque baffles configured to reduce scattering and/or crosstalk.

14. The film of claim 1 comprising at least one gradient that couples light from an angle other than the gradient axis.

15. The film of claim 1 further comprising a surface shaped lens element configured in relationship to at least one aspheric gradient.

16. The film of claim 1, wherein the film is configured to couple EM radiation orthogonally into or out of a surface of the photonic device where EM radiation emitted from any gratings in the waveguide is not orthogonal to the surface of the surface of the photonic device.

17. The film of claim 1 comprising at least one gradient-index function optimized for changing the shape of a light beam from one shape to another by altering the distribution of a light beam's intensity profile or its phase profile.

18. The film of claim 1 comprising at least one optical channels optimized for coupling light from a grating.

19. The film of claim 1 comprising a gradient-index function optimized for in-coupling or outcoupling EM radiation at a direction orthogonal to the photonic device.

20. A gradient-index optical film for coupling oriented EM radiation to or from a photonic integrated circuit, photonic imaging device, optical phased array, light-field display, lightfield imager, holographic display, or a micro-emitter array, the film comprising:
at least one gradient-index function optimized for mode matching to a waveguide.

21. (canceled)

22. (canceled)
